(19) United States
(12) Patent Application Publication
(10) Pub. No.: US 2018/0297658 A1
(43) Pub. Date: Oct. 18, 2018

(54) Clamping Device, in Particular for Clamping a Saddle for a Cycle

(71) Applicant: Smoove, Saint-Gely-du-Fesc (FR)

(72) Inventor: Denis Mercat, Sainte Foy les Lyon (FR)

(21) Appl. No.: 15/951,396

(22) Filed: Apr. 12, 2018

(30) Foreign Application Priority Data
Apr. 12, 2017 (FR) 1753203

(51) Int. Cl. B62J 1/08; F16B 2/08

(52) U.S. Cl. CPC B62J 1/08; F16B 7/1418; F16B 2/08

(57) ABSTRACT

This clamping device includes a clamping collar intended to surround an element to be clamped and open so as to have two ends able to come closer to one another in order to grip the element to be clamped. This device also includes a lever, mounted tilting on the ends of the collar around a tilting axis perpendicular to a central axis of the collar, and connected to the collar by a cam system able to be actuated by tilting the lever. The cam system includes at least one pair associating a cam surface and a counter-cam surface, which are each globally helical and which are respectively connected in rotation to the collar and the lever. The cam surface of each pair includes a first surface portion, against which the counter-cam surface is pressed when the lever is in an open position and is tilted from the open position to a closed position, and a second surface portion, which is connected to the first portion and against which the counter-cam surface is pressed when the lever is in the closed position and tilted from the closed position toward the open position. The counter-cam surface includes a main part, which is helical, while being centered on the tilting axis and having a constant pitch, and which is pressed along the tilting axis against the second surface portion of the associated cam surface when the lever is in the closed position. Furthermore, the cam surface defines a bearing helix at which the bearing stresses are applied between the cam and counter-cam surfaces, this bearing helix winding around the tilting axis and extending at least partially over the first and second portions. In order to improve this clamping device, in particular for its use on rental cycles, the bearing helix of the cam surface has a helix angle that is larger on the first portion than on the second portion of the cam surface, while this second portion of the cam surface has a pitch that is substantially equal to the constant pitch of the main part of the associated counter-cam surface.

### CROSS-REFERENCE TO RELATED APPLICATIONS

This application claims the benefit of French Application No. 1753203, filed on Apr. 12, 2017, which is incorporated herein by reference in its entirety.

### FIELD OF THE INVENTION

The present invention relates to a clamping device. It in particular, but not exclusively, relates to such a device for clamping the saddle of a cycle.

### BACKGROUND OF THE INVENTION

Cycles, in particular bicycles, are provided with a saddle that the user generally wishes to be able to adjust heightwise for obvious comfort and practicality reasons. The saddle is supported at the apex of a seatpost, which in turn is received sliding in an ad hoc tube of the frame of the cycle: once the height of the saddle relative to the frame is adjusted, i.e., once the seatpost is slid in the aforementioned tube to a desired position on this tube, the seatpost must be immobilized relative to the tube. To that end, it is known to use a clamping device, which is actuated manually by the user and which clamps the tube on the seatpost to immobilize it.

The invention examines clamping devices comprising, on the one hand, a clamping collar, which coaxially surrounds the aforementioned tube and which is open so as to have two ends which, by deformation of the clamping collar, come closer to one another in order to clamp the tube, and on the other hand, a lever, which is mounted sliding on the ends of the clamping collar around a tilting axis perpendicular to a central axis of the clamping collar. This lever is connected to the clamping collar by a cam system, able to be actuated by tilting of the lever around the tilting axis between an open position, in which the clamping collar is loosened, and a closed position, in which the clamping collar is tightened. WO 2012/066215 and EP 2,927,517 disclose clamping devices of this type: in WO 2012/066215, each end of the clamping collar delimits a helical cam surface against which a helical counter-cam surface is directly pressed, delimited by the end of a corresponding arm of the lever; in EP 2,927,517, a sliding washer made from a material with a low friction coefficient is inserted between helical cam and counter-cam surfaces that are similar to those of WO 2012/066215. In both cases, each cam surface and its associated counter-cam surface:
have a constant pitch, i.e., these surfaces wind around the tilting axis with a pitch that does not vary around this axis, and
are each provided with respective inner and outer radii that are constant, i.e., that do not vary around the tilting axis.
   This solution is not satisfactory, for the reasons explained below in light of FIGS. 1 to 5.

A cam surface that is helical with a constant pitch is characterized by the fact that its axial travel, i.e., its travel along the tilting axis defined above, varies in proportion to the angular travel of this surface, i.e., its travel around the tilting axis. This amounts to saying that the axial travel and the angular travel of this helical cam surface are connected by a linear function. Of course, once the helical surface performs a complete revolution around itself around the tilting axis, in other words, it performs an angular travel of 360°, a given point of this helical surface moves axially by a travel equal to the pitch of the surface. This being said, the actual travel of this point, which is in the form of a circular helix centered on the tilting axis, has a length that depends on the separation of this point with respect to the tilting axis: when this point is situated at a distance from the tilting axis equal to the outer radius, denoted rext, of the helical surface measured relative to the tilting axis and this radius rext is constant over the entire expanse of the helical surface around the tilting axis, this point travels a circular helix that forms the outer contour of the helical surface and that has a length 2.π.rext and a helix angle denoted βᵣₑₓₜ; but when this point is located at a distance from the tilting axis equal to the inner radius, denoted rint, of the helical surface measured relative to the tilting axis and this radius rint is constant over the entire expanse of the helical surface around the tilting axis, this point travels a circular helix that forms the inner perimeter of the helical surface and that has a length of 2.π.rint and a helix angle denoted βᵣᵢₙₜ. FIG. 1 thus illustrates the linear function linking the axial travel and the angular travel of the helical surface, along the considered helix of this helical surface. It is thus in particular understood that the value of the pitch of the helical surface, denoted p, and a helix belonging to the latter, having a radius, denoted r and measured relative to the aforementioned tilting axis, and a helix angle, denoted βᵣ and measured relative to a plane perpendicular to the tilting axis, are linked by the relationship:

βᵣ=arctan(p/(2.π.r)). (1)

The arc tangent function (arctan) being strictly increasing, it is understood that, based on this relationship (1), the helix angle βᵣ increases with the pitch p and decreases with the radius r, the helix angle and the radius being independent of one another.

Furthermore, the friction phenomenon between two parts, in particular between a helical cam surface and counter-cam surface, causes there to be no sliding if the resultant force is comprised in a so-called friction cone, which corresponds to a cone of revolution, which has, for axis, the normal to the contact between the cam surface and the counter-cam surface and the half cone angle a of which for value φ corresponding to the arctangent of the friction coefficient of the pair of materials respectively making up the cam surface and the counter-cam surface. If the angle of the resultant force is outside or inside the friction cone, the parts do or do not begin to slide relative to each other. FIG. 2 shows these two situations. The left part of FIG. 2 shows the linear development of the inner perimeter of a helical cam surface with a constant pitch, this inner perimeter being associated with a radius rint and helix angle βᵣᵢₙₜ, as mentioned above. The right part of FIG. 2 shows the linear development of the outer perimeter of the same helical cam surface with a constant pitch, this outer perimeter being associated with a radius rext and a helix angle βᵣₑₓₜ, also as previously mentioned. When one wishes to apply an axial force through this helical cam surface and counter-cam surface pair, in other words, a force oriented parallel to the aforementioned tilting axis, a different operation is observed for the inner perimeter of the cam surface, shown on the left, and for the outer perimeter of this cam surface, shown on the right:
on the inner perimeter, one can see that the axial component of the force, denoted R_{1X}, does not enter the friction cone crosshatched in FIG. 2, which is related to the fact that the helix angle βᵣᵢₙₜ is greater than φ; the transmission of the force then generates a tangent component R_{1T} causing the cam surface and the counter-cam surface to slide relative to one another; the cooperation between the cam surface and the counter-cam surface, at a small radius, is therefore unstable and reversible, such that axial thrust causes a rotation between the cam surface and the counter-cam surface;
on the outer perimeter, one can see that the axial component of the force, denoted R_{2X}, is located inside the friction cone crosshatched in FIG. 2, which is related to the fact that the helix angle βᵣₑₓₜ is less than φ; thus, the transmission of the force does not generate any sliding between the cam surface and the counter-cam surface; the cooperation between the cam surface and the counter-cam surface at a large radius is therefore stable and irreversible, such that axial thrust does not cause a rotation between the cam surface and the counter-cam surface.

In practice, to characterize the operation of such a system, it is possible to consider that the cam surface globally behaves like at an intermediate helix of this cam surface, this intermediate helix being situated between its inner perimeter and its outer perimeter. When the pressure exerted through the cam surface is constant, one demonstrates that the radius of the intermediate helix, which can be qualified as equivalent radius, denoted req, is determined by the following relationship:

req=⅔·(rext³−rint³)/(rext²−rint²). (2)

One therefore understands that a helical cam surface, with a constant pitch and with inner and outer perimeters with constant respective radii, has a fairly uncertain behavior, inasmuch as it is not certain that the contact pressure through this cam surface will in fact be constant and applied on the intermediate helix associated with the radius calculated according to relationship (2), having stressed that the wear and machining allowances, inter alia, affect the situation.

This results, in the device according to WO 2012/066215, in a lack of stability of the lever in the open position, as well as a lack of stability of the lever in the closed position. To partially compensate this lack of stability, the sliding washer used in EP 2,927,517 claims to stabilize the lever in the closed position, but accentuates the lack of stability in the open position.

To bypass the issue of stability described thus far, it is possible to consider reducing the value of the pitch of the cam surface(s) used in the devices of WO 2012/066215 and EP 2,927,517, but this directly affects the maximum axial travel allowed, for a given angular travel, by this or these cam surfaces in order for the device to grip the tube around the seatpost. Once this maximum axial travel is too small, the following occurs:
even with the lever in the open position, a substantial clamping stress risks being applied by the clamping collar around the tube, such that it is difficult for the user to raise or lower the seatpost, the inside of the tube scratches the seatpost, damaging the anodization or paint of this post, and there is even a risk of seizing and/or wear of the seatpost in the tube; and
even with the lever in the closed position, the device risks not clamping the tube enough, the weight of the user being be sufficient to drive the seatpost inside the tube despite the clamping of the lever such that during use, the seat lowers or pivots, which wears on the post and which is particularly uncomfortable for the cyclist.

Added to the foregoing technical considerations is another critical aspect for this type of clamping device, namely, on the one hand, its dynamic behavior, i.e., in clamping and loosening, i.e., when the lever respectively goes from its open position to its closed position and from its closed position to its open position, and on the other hand, its static behavior.

The clamping operation of a helical cam surface with a constant pitch and with inner and outer perimeters having constant respective radii is illustrated by FIG. 3, considering that the cam is rotated around the tilting axis such that a clamping force F is applied on the cam that can be broken down into:
an axial force component F_{X} along the aforementioned tilting axis, and
a tangent force component F_{T} orthoradial to the tilting axis.

Taking account of φ defined above, the helix angle βᵣ and the radius r of a given helix of the cam surface, helix where the force F is applied, are linked by the relationships:

tan(φ+βᵣ)=F_{T}/F_{X}, (3)

C=F_{T}.r=F_{X}.r.tan(φ+βᵣ), and (4)

η=100.tan(βᵣ)/tan(βᵣ+φ), (5)

C being the torque that must be produced by the user to generate the clamping force and q being the yield, in percentage, of the corresponding clamping.

The loosening operation of this helical cam surface with a constant pitch and with inner and outer perimeters having constant respective radii is illustrated by FIG. 4, considering that the cam is rotated around the tilting axis such that a loosening force F is applied on the cam that, just as before, is be broken down into an axial component F_{X} and a tangent component F_{T}. The helix angle βᵣ and the radius r of a given helix of the helical surface, helix where the force F is applied, are linked by the relationships:

tan(φ−βᵣ)=F_{T}/F_{X}, and (6)

C=−F_{T}.r=−F_{X}.r.tan(φ−βᵣ), (7)

C being the torque that the user must produce to generate the loosening force F.

The static operation of this helical cam surface with a constant pitch and with inner and outer perimeters having constant respective radii is illustrated by FIG. 5: the cam is immobile, in particular not rotated around the tilting axis, so as to generate a force F limited to an axial component F_{X}, its tangent component F_{T} being zero. Of course, the cam surface is thus blocked with respect to the counter-cam surfaces long as φ is greater than the helix angle βᵣ for all, or at the very least nearly all, of the helices forming the cam surface.

The various considerations above illustrate the complexity of designing a clamping device of the type mentioned above, in particular when this device is intended to be used in a particularly demanding frame, in particular that of rental cycles. Indeed, the seat height of a rental cycle must be able to be adjusted simply and intuitively, requiring little effort from the user, while guaranteeing effective locking, and sustainably, i.e., withstanding both intensive use, for example several tens of adjustments per day, and exposure to bad weather and vandalism.

WO 2007/075735 in turn discloses a locking mechanism making it possible to lock a cycle axle shaft reversibly on the frame of a cycle. This locking mechanism comprises a cam system including three pairs each associating a cam surface and a counter-cam surface, which are respectively supported by parts of the mechanism, rotatable relative to one another around an axis centered on the cycle axle shaft. The cam surface of each of the three aforementioned pairs is globally helical, while having a pitch that varies continuously around the axis over the entire functional expanse of the cam surface, while the associated counter-cam surface assumes the form of a cylindrical lug that is pressed axially against the cam surface. The bearing of the cylindrical end of these lugs, which has a small curve radius, against the cam surface with a continuously variable pitch causes a very high contact pressure, in particular when the aforementioned parts of the mechanism occupy a relative angular position in which the mechanism is intended to retain the axle shaft on the frame of the cycle: the aforementioned parts of the mechanism are subject to an extremely high constant load, in particular when the mechanism retains the axle shaft on the frame of the cycle, which requires these parts to be made from hard metal, typically steel, to prevent creeping thereof. However, the use of metal causes practical drawbacks, related to the weight and cost of the metal parts, as well as the need to provide a treatment for the parts to increase the hardness thereof and/or lubrication to limit seizing, wear and corrosion problems due to friction.

### BRIEF SUMMARY OF THE INVENTION

The aim of the present invention is therefore to improve the clamping devices of the type described thus far, in particular to use them on rental cycles.

To that end, the invention relates to a clamping device, in particular for clamping a seat for a cycle, this device including:
a clamping collar, which defines a central axis, which is intended to surround, in a substantially coaxial manner, an element to be clamped, in particular a tube for receiving a seatpost, and which is open so as to have two ends able to come closer to one another in order to grip the element to be clamped, and
a lever, which is mounted tilting on the ends of the clamping collar around a tilting axis extending substantially perpendicular to the central axis, and which is connected to the clamping collar by a cam system which is able to be actuated by tilting of the lever around the tilting axis between an open position, in which the clamping collar is loosened, and a closed position, in which the clamping collar is tightened;

wherein the cam system includes at least one pair associating a cam surface and a counter-cam surface, which are each globally helical, winding around the tilting axis, and which are connected in rotation around the tilting axis, respectively, to one of the clamping collar and the lever and to the other of the clamping collar and the lever;

wherein the cam surface of the or each pair of the cam system includes:
a first surface portion against which the associated counter-cam surface is pressed along the tilting axis both when the lever is in the open position and when the lever is tilted from the open position toward the closed position, and
a second surface portion, which is connected to the first surface portion by a third surface portion of the cam surface, and against which the associated counter-cam surface is pressed along the tilting axis both when the lever is in the closed position and when the lever is tilted from the closed position toward the open position;

wherein the counter-cam surface of the or each pair of the cam system includes a main part, which is helical, being centered on the tilting axis and having a constant pitch, and which is pressed along the tilting axis against the second surface portion of the associated cam surface when the lever is in the closed position;

wherein the cam surface of the or each pair of the cam system defines a bearing helix at which bearing stresses are applied between the cam surface and the associated counter-cam surface, said bearing helix winding around the tilting axis and extending at least partially over the first and second surface portions of the cam surface; and

wherein the bearing helix of the cam surface of the or each pair of the cam system has a helix angle, measured relative to a plane perpendicular to the tilting axis, that is larger on the first surface portion of the cam surface than on the second portion of the cam surface, while this second portion of the cam surface of the or each pair of the cam system has a pitch that is substantially equal to the constant pitch of the main part of the associated counter-cam surface.

Owing to the variation in the helix angle of the bearing helix defined by the or each cam surface of the clamping device, the invention makes it possible that:
when the lever is in the closed position, the cooperation between the or each cam surface and the associated counter-cam surface is stable, while producing a substantial axial force component,
when the lever is in the open position, the cooperation between the or each cam surface and the associated counter-cam surface is reversible, which keeps the lever in the open position despite the effect of the weight inherent to the lever tending to cause it to tilt toward the closed position, and
when the lever is tilted from its open position to its closed position by driving from the user, the latter only needs to apply a limited torque owing to good local performance of the cam surface.

Furthermore, it will be noted that the invention thus goes against the prejudice according to which, once a helical cam surface is made from a material susceptible to creep and therefore to lead to a gradual decrease over time in the intensity of the clamping produced by the device, only a congruent bearing interface between the cam surface and the counter-cam surface can be considered over the entire relative angular travel between these surfaces, which necessarily leads to the cam surface and the counter-cam surface having constant pitches with the same absolute value over their entire functional expanse. Owing to the variation in the helix angle of the bearing helix of the or each cam surface, the invention makes it possible that, during clamping and loosening of the device, the contact pressure between the or each cam surface and the counter-cam surface is, granted, high, but this high pressure only occurs for a very short duration corresponding to the transitional passage phases of the lever between its open and closed positions, with no risk of creep for the material making up the cam surface(s). Furthermore, during these transitional phases, the axial clamping travel is still small, such that the axial force generated is still far from reaching the maximum obtained at the end of travel during clamping. When the lever goes from the open position to the closed position, the axial force only begins to increase quickly when the aforementioned transitional phase ends and the lever reaches the closed position: the respective pitches of the cam surface and the counter-cam surface then become identical such that the shared interface will not stop growing until the final clamping to limit the contact pressure generated by the increasing axial force induced by the clamping. This feature of growth of the contact interface is novel and even contrary relative to the prior art, in particular relative to the aforementioned prior art documents, in that in WO 2012/066215, the contact interface only decreases with clamping, and in WO 2007/075735, the contact interface remains substantially linear and very small over the entire relative travel between the rotating parts of the locking mechanism.

When the lever is in the closed position, creep is avoided by providing that the portion of the cam surface and the portion of the counter-cam surface, which are then pressed against each other, are helical and have a same pitch, which makes it possible to distribute, over a large bearing interface, the substantial axial force component produced by the cooperation between the or each cam surface and the associated counter-cam surface. The invention thus makes it possible to produce the cam surface(s) of its device from a thermoplastic material, which is simultaneously cost-effective, in particular in connection with the possibility of producing the cam surface(s) by injection, high-performing to limit the friction coefficient, and wear-resistant, in particular compared to metals.

In practice, as explained in more detail below, the bearing helix, along which the helix angle varies according to the invention, can either be made in the form of a peak, or defined geometrically in connection with relationship (2) provided above. Also as explained in more detail below, the invention sets out, to vary the helix angle of this bearing helix, playing either with a variation of the pitch of the or each cam surface, or a variation of the radius of the bearing helix, or a combination of the two aforementioned variations.

According to additional advantageous features of the clamping device according to the invention:
The cam surface of the or each pair of the cam system is curved so as to form a peak for concentrating the bearing stresses between the cam surface and the associated counter-cam surface, said peak forming the bearing helix.
The cam surface of the or each pair of the cam system has, in section in any axial plane containing the tilting axis and intersecting the cam surface, a rectilinear profile, and the bearing helix corresponds to a geometric helix, which is centered on the tilting axis and which, in section in any axial plane containing the tilting axis and intersecting the cam surface, has a radius that is equal to ⅔·(rext³−rint³)/(rext²−rint²), where rext and rint are outer and inner radii, respectively, of the cam surface, measured in said axial plane.
The cam surface of the or each pair of the cam system has a pitch that is larger on the first surface portion of the cam surface than on the second portion of the cam surface.
The bearing helix of the cam surface of the or each pair of the cam system has a radius, measured relative to the tilting axis, that is smaller on the first surface portion of the cam surface than on the second portion of the cam surface.
The helix angle of the bearing helix of the cam surface of the or each pair of the cam system is:
   greater than 13°, or even greater than 14° over substantially the entire first surface portion of the cam surface, and
   less than 6°, or even less than 5° over substantially the entire second surface portion of the cam surface.
The second surface portion of the cam surface of the or each pair of the cam system is congruent with the associated counter-cam surface.
The cam surface of the or each pair of the cam system further includes a fourth surface portion that extends from the second surface portion opposite the third surface portion, being connected to the second surface portion continuously, and the pitch of the cam surface of the or each pair of the cam system is larger on the fourth surface portion of the cam surface than on the second surface portion.
The cam system includes:
   two pairs whose respective cam surfaces are symmetrical to one another relative to the tilting axis, and/or
   two pairs whose respective cam surfaces are respectively arranged on either side, along the tilting axis, of the two ends of the clamping collar.
The cam system includes at least one cam part:
   that is distinct from the clamping collar and the lever, while being interposed, along the tilting axis, between the lever and one of the ends of the clamping collar,
   which, for each pair of the cam system, delimits, on a first face of the cam part, either the corresponding cam surface, or the corresponding counter-cam surface, and
   which, on a second face of the cam part that is opposite the first face along the tilting axis, is provided with a cylindrical surface, which is centered on a pivot axis parallel to the central axis and secant to the tilting axis, and which cooperates by shape matching with a cylindrical surface of the clamping collar such that the cam part is both connected in rotation around the tilting axis to the clamping collar and pressed along the tilting axis against the collar, while allowing pivoting travel around the pivot axis.
The clamping device further comprises a journal, which traverses the two ends of the clamping collar while being centered on the tilting axis, which is connected in rotation around the tilting axis to the lever, and which is provided, in an axially opposite manner along the tilting axis, with a head and a thread to which a nut is screwed, such that the two ends of the clamping collar, the lever and the cam system are gripped, along the tilting axis, between the head and the nut, and the nut includes a bearing face, which is pressed, along the tilting axis, against an indexing face of the lever, while cooperating with this indexing face, in particular by shape matching, so as to lock the rotation of the nut around the tilting axis relative to the latter in a plurality of indexed positions, passing the nut between two of these indexed positions being operated by axial separation between the bearing face and the indexing face.
One of the bearing face and the indexing face is provided with a plurality of concave spherical caps, which are distributed around the tilting axis while defining the plurality of indexed positions, and the other of the bearing face and the indexing face is provided with at least one convex spherical cap that is selectively received in a complementary manner in one of the concave spherical caps.
The clamping device further comprises at least one spring that is interposed, along the tilting axis, between the journal and the lever so as to press the bearing face and the indexing face against each other along the tilting axis.
The clamping collar is provided to be resilient such that, even when the lever is in the open position, the clamping collar exerts a resilient stress that moves the two ends of the clamping collar away from each other.
The cam surface of the or each pair of the cam system is made from a thermoplastic material, in particular polyacetal or PBT.

### BRIEF DESCRIPTION OF THE DRAWINGS

The invention will be better understood upon reading the following description, provided solely as an example and done in reference to the drawings, in which:

FIGS. 1 to 5 are schematic graphs that have been previously described, in connection with a helical cam surface having a constant pitch,

FIGS. 6 to 8 are perspective views, from different respective viewing angles, of an exploded view of a clamping device according to the invention, a lever of this device being in the closed position;

FIG. 9 is a perspective view of a cam part, shown alone, belonging to the clamping device of FIGS. 6 to 8;

FIG. 10 is an elevation view along arrow X of FIG. 9;

FIG. 11 is a perspective view of the clamping device of FIGS. 6 to 8, shown in the assembled state and while the lever of this device is in the open position;

FIG. 12 is an elevation view along arrow XII of FIG. 11;

FIG. 13 is a sectional view along line XIII-XIII of FIG. 12;

FIG. 14 is a view similar to FIG. 12, illustrating the clamping device with its lever in the closed position;

FIGS. 15 and 16 are sectional views along lines XV-XV and XVI-XVI of FIG. 14;

FIG. 17 is a sectional view along line XVII-XVII of FIG. 16;

FIG. 18 is a sectional view along line XVIII-XVIII of FIG. 17;

FIG. 19 is a schematic graph showing the evolution of the axial travel of the cam part of FIGS. 9 and 10 as a function of an angular dimension of a cam surface of this cam part;

FIG. 20 is a schematic graph showing the evolution of a radius of a peak of the aforementioned cam surface as a function of the angular dimension of the latter;

FIG. 21 is a schematic graph showing the evolution of the helix angle of the aforementioned peak as a function of the angular dimension of the aforementioned cam surface;

FIG. 22 is a schematic graph showing the evolution of the performance of the clamping by the aforementioned cam surface as a function of the angular dimension of the latter;

FIG. 23 is a schematic graph showing the evolution of the torque to be applied to the lever of the device of FIGS. 6 to 8 to clamp this device, and

FIG. 24 is a view similar to FIG. 23, showing the evolution of the torque to loosen the device.

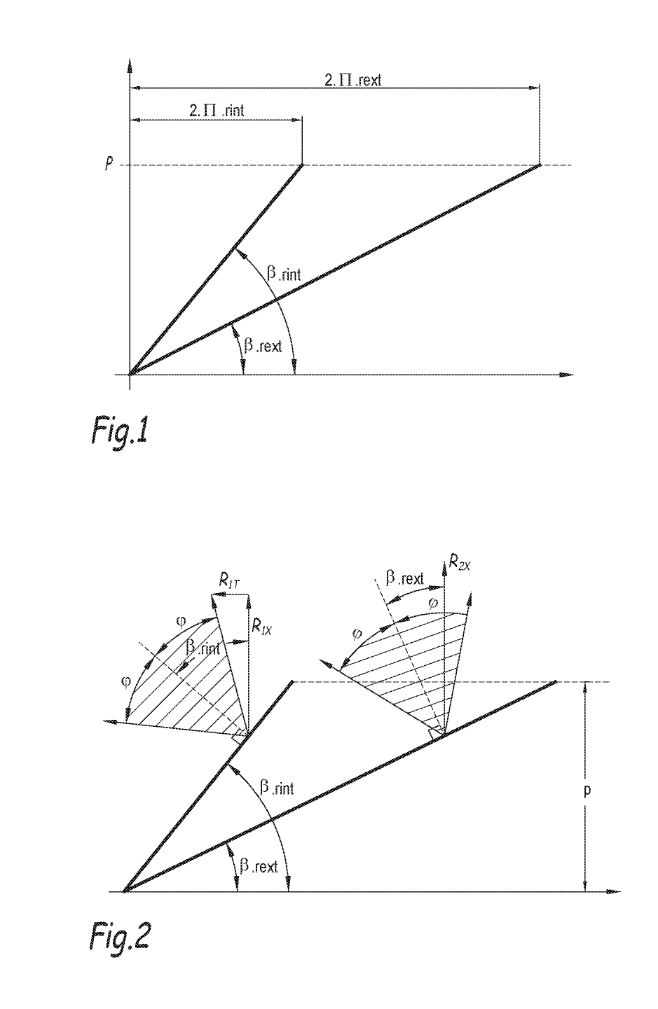

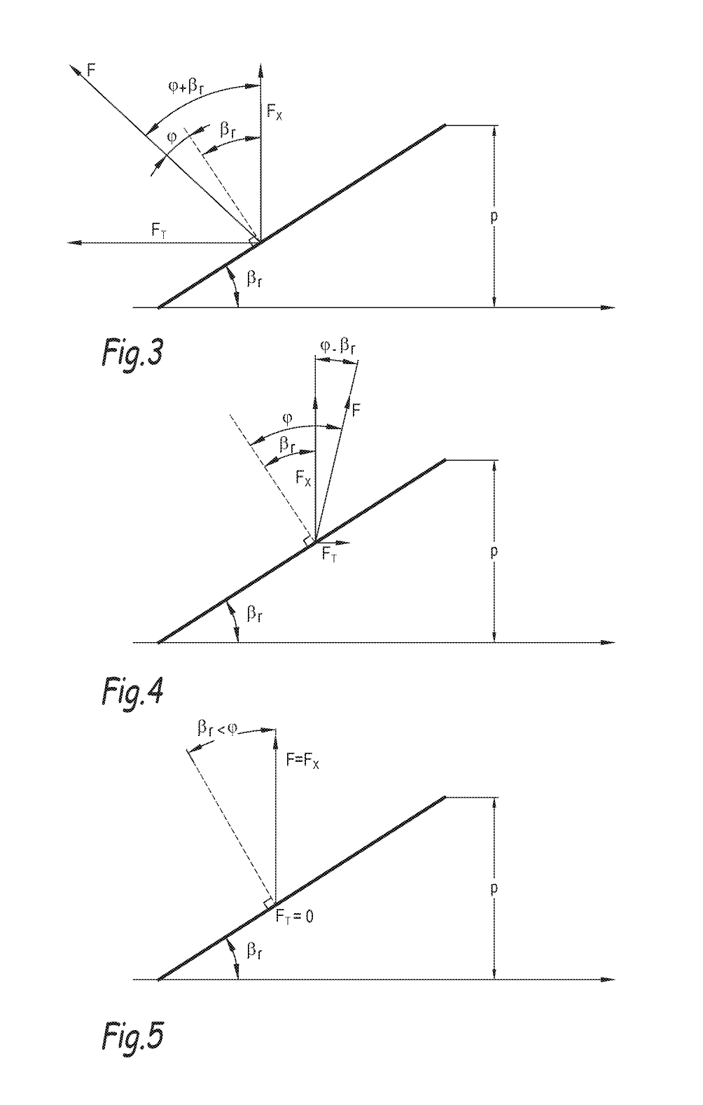

### DETAILED DESCRIPTION OF THE INVENTION

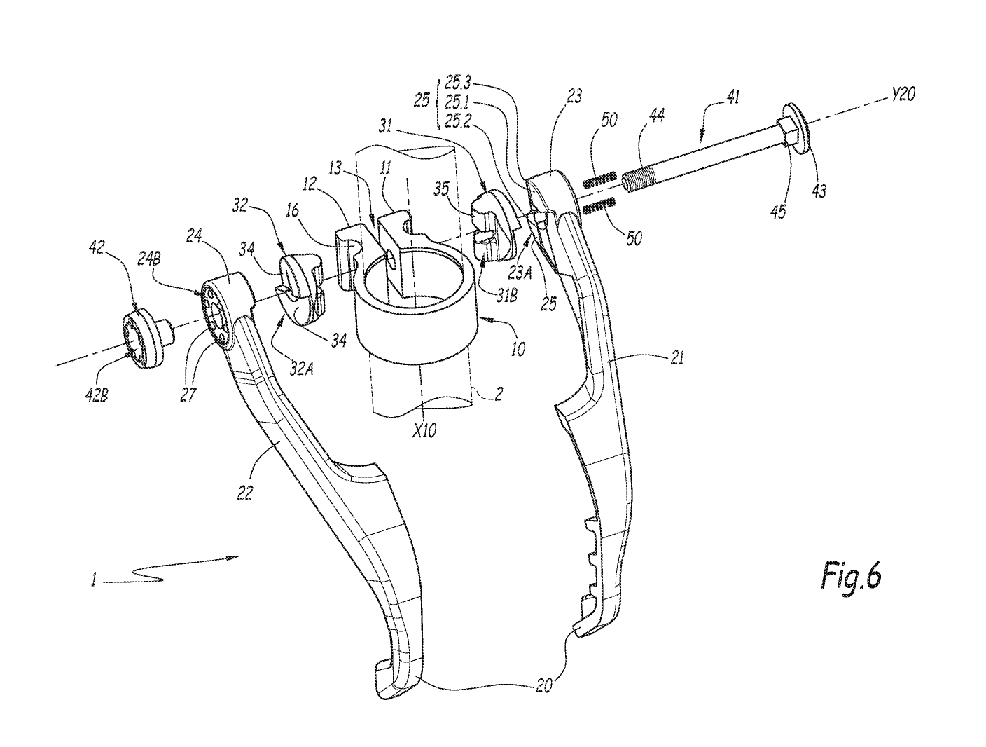

FIGS. 6 to 18 show a clamping device 1 making it possible to clamp an element to be clamped 2, which is only shown in FIG. 6, and only partially and schematically, in dotted lines. As mentioned in the introductory part, the element to be clamped 2 may in particular be a tube of a frame of a cycle, in particular a frame of a cycle, inside which a seatpost, not shown, is coaxially received, in turn topped by a seat, also not shown. For all useful purposes, the reader may refer to documents WO 2012/066215 and EP 2,927,517 for additional details relative to such a frame tube receiving such a seatpost, having recalled that these aspects are not limiting with respect to the present invention.

As shown in FIGS. 6 to 8 and 11 to 18, the clamping device 1 includes a clamping collar 10 that is globally omega-shaped. The clamping collar 10 defines a central axis X10 around which the clamping collar extends while defining, inside the clamping collar, a free space, globally cylindrical and centered on the axis X10: during use, the element to be clamped 2 is placed inside the aforementioned free space such that the clamping collar substantially coaxially surrounds the element to be clamped 2, as shown schematically in FIG. 6.

The clamping collar 10 is open at a point of its periphery: the clamping collar 10 thus has two ends 11 and 12 that are separated from each other, in a direction orthoradial to the axis X10, by a slit 13. By playing on the opening-closing of the slit 13, in other words by separating/bringing together the ends 11 and 12 across from one another, subject to the deformation of the clamping collar 10, the latter more or less strongly clamps the element to be clamped 2, in particular to lock/unlock the aforementioned seatpost or a similar member received inside the element to be clamped 2.

Also as clearly shown in FIGS. 6 to 8 and 11 to 18, the clamping device 1 includes a lever 20 that commands the deformation of the clamping collar 10 by acting on the ends 11 and 12 of the latter. More specifically, the lever 20 is mounted tilting on the ends 11 and 12 around a tilting axis Y20, which extends substantially perpendicular to the central axis X10 and offset relative to this central axis, while passing through the ends 11 and 12 of the clamping collar 10. In practice, like in the example embodiment considered here, the tilting axis Y20 extends in the orthoradial direction in which the ends 11 and 12 are separated by the slit 13.

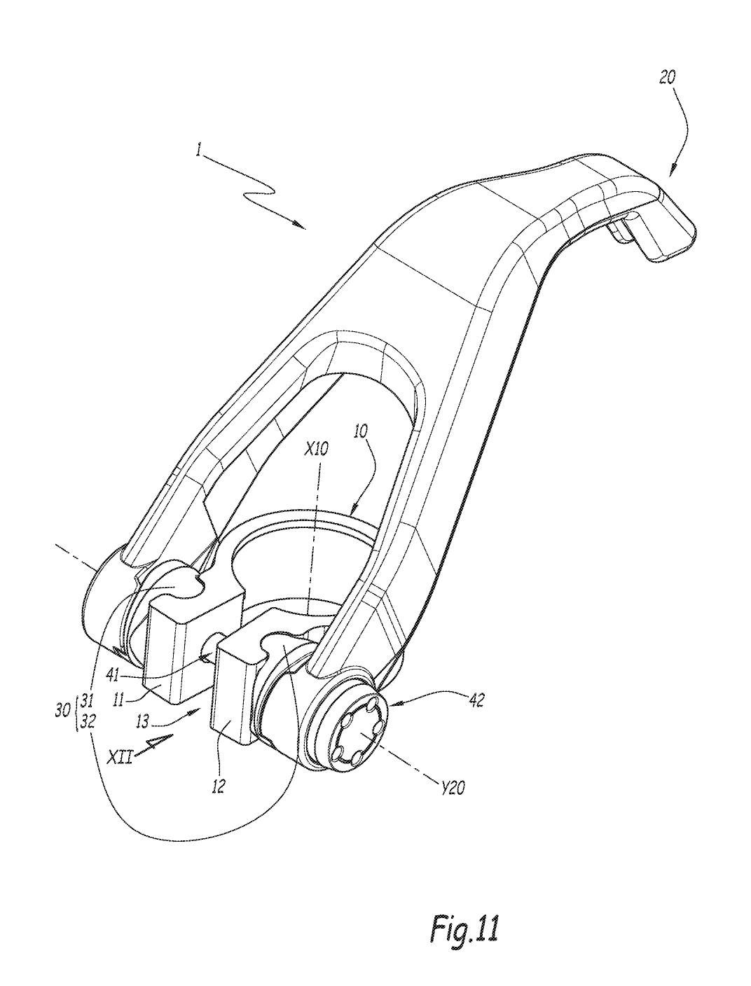

During use, the lever 20 is provided to be actuated by a user subject to the tilting of this lever around the tilting axis Y20, in opposite directions to selectively clamp and loosen the clamping collar 10. Thus, to clamp the clamping collar 10, the lever 20 is tilted from an open position, shown in FIGS. 11 to 13, to a closed position, shown in FIGS. 6 to 8 and 14 to 18. The angular travel, around the tilting axis Y20, of the lever 20 between these open and closed positions is not limiting with respect to the invention, with the understanding that it is typically less than 360°, in particular less than 180°, or even substantially equal to 90° in the context of use of the clamping device 1 to clamp the seat of a cycle. In the rest of the description, as well as the example embodiment considered in the figures, the angular travel of the lever 20 between these open and closed positions is considered to be equal to 90°.

The embodiment of the lever 20 is not limiting inasmuch as this lever can be manipulated by hand by a user in order to tilt it around the tilting axis Y20. In particular, the geometry of the overall shape of this lever 20 is not limited to that shown in the figures, having also noted that, for illustration reasons, the lever 20 is drawn as being split into two parts in FIGS. 6 to 8, whereas it can be made in a single part, as clearly shown in FIGS. 11, 12 and 14.

In the embodiment considered in the figures, the lever 20 includes two arms 21 and 22, which extend transversely to the tilting axis X20. These arms 20, 21 and 22 are positioned on either side, in the direction of the tilting axis Y20, of the clamping collar 10, while being separated from each other enough to allow the clamping collar 10 to pass between these arms 21 and 22 during the tilting of the lever between the open and closed positions. At their end opposite the tilting axis Y20, the arms 21 and 22 come back together to form a manual gripping zone. Opposite this gripping zone, the arms 21 and 22 respectively have ends 23 and 24, which are both traversed by the tilting axis Y20 and between which the ends 11 and 12 of the clamping collar 10 are interposed.

Also as shown in FIGS. 6 to 8 and 11 to 18, the clamping device 1 further includes a cam system 30 that mechanically connects the lever 20 to the ends 11 and 12 of the clamping collar 10 and which acts in translation, along the tilting axis Y20, on the ends 11 and 12 of the clamping collar in order to bring them closer together/further away with respect to each other, during the tilting of the lever 20 around the tilting axis Y20 between the open and closed positions of this lever. In the example embodiment considered in the figures, the cam system 30 includes two cam parts 31 and 32, between which are interposed, along the tilting axis Y20, the ends 11 and 12 of the clamping collar 10, the cam part 31 being axially interposed between the end 11 and the end 23 of the lever 20 while the cam part 32 is axially interposed between the end 12 and the end 24 of the lever 20. Each of the cam parts 31 and 32 is traversed by the tilting axis Y20 and delimits, on its face 31A, 32A, respectively, turned toward the end 23 of the lever 20, the end 24 of the lever 20, respectively, at least one cam surface 33, 34, respectively. In the example embodiment considered in the figures, the face 31A, respectively 32A of the cam part 31, respectively 32, includes two cam surfaces 33, respectively two cam surfaces 34, that follow one another around the tilting axis Y20 and that will be described in detail later.

Opposite, along the tilting axis Y20, the face 31A, respectively 32A, of the cam part 31, respectively 32, the latter has a face 31B turned toward the end 11 of the clamping collar 10, respectively 32B turned toward the end 12 of the clamping collar 10. The faces 31B and 32B are respectively engaged with the ends 11 and 12 of the clamping collar 10, so as to connect the cam parts 31 and 32 and the ends 11 and 12 of the clamping collar in rotation, around the tilting axis Y20. The embodiment of this engagement is not limiting, multiple solutions being able to be considered as long as the latter simultaneously provide the rotating connection around the tilting axis Y20 between the cam parts and the ends of the clamping collar, and the transmission of the driving between the cam parts and the ends of the clamping collar when the ends of the clamping collar are brought relatively closer together and further away along the tilting axis Y20.

Thus, a first solution, not shown in the figures, consists of rigidly linking the cam parts 31 and 32, respectively to the ends 11 and 12 of the clamping collar 10, using any appropriate means, such as lugs, glue, etc. In an alternative of this first solution that is not shown, it is even possible to consider the cam parts being integral with the ends 11 and 12 of the clamping collar, respectively, which amounts to saying that, unlike the embodiment considered thus far, the cam parts 31 and 32 are not separate from the clamping collar and the cam surfaces 33 and 34 are delimited by material extensions of the ends 11 and 12 of the clamping collar.

Another solution is considered for the example embodiment considered in the figures: the face 31B, respectively 32B of the cam part 31, respectively 32, includes a cylindrical surface 35, respectively 36, that is centered on a pivot axis X35, respectively X36, that is both parallel to the central axis X10 of the clamping collar 10 and secant to the tilting axis Y20, as clearly shown in FIGS. 13 and 15. The cylindrical surface 35, respectively 36, cooperates, by shape matching, with a cylindrical surface 15, respectively 16, delimited by the end 11, respectively 12, of the clamping collar 10, such that the cam part 31, respectively 32, is connected in rotation around the tilting axis Y20 to the end 11, respectively 12, of the clamping collar 10 and is pressed along this tilting axis Y20 against this end 11, respectively 12, while allowing pivoting travel around the pivot axis X35, respectively X36, between the cam part 31 and the end 11, respectively between the cam part 32 and the end 12. In the example embodiment shown in the figures, the cylindrical surfaces 35 and 36 are convex and the cylindrical surfaces 15 and 16 are concave, with the understanding that as an alternative that is not shown, the direction of the curves of these surfaces can be reversed. In all cases, the pivoting travel allows the cam parts 31 and 32 to accommodate the change in the incline of the ends 11 and 12 of the clamping collar 10 relative to the tilting axis Y20 when these ends 11 and 12 are brought relatively closer together/further apart, without changing the corresponding incline of the cam parts 31 and 32, as clearly shown by comparing FIGS. 13 and 15.

Returning to the description of the cam system 30, the latter also comprises counter-cam surfaces 25 and 26, which are connected in rotation, around the tilting axis Y20, to the lever 20, and which, during use, are pressed, along the tilting axis Y20, against the cam surfaces 33 and 34 of the cam parts 31 and 32. More specifically, in the example embodiment considered in the figures, two counter-cam surfaces 25 are provided on a face 23A of the end 23 of the lever 20, turned along the tilting axis Y20 toward the end 11 of the clamping collar 10, and two counter-cam surfaces 26 are provided on a face 24A of the end 24 of the lever 20, turned toward the end 12 of the clamping collar. For each of the faces 23A and 24A, the two counter-cam surfaces 25, respectively 26, are symmetrical to one another relative to the tilting axis Y20 and each extend over about 90° around the tilting axis Y20, while being separated from each other by two angular, diametrically opposite regions of the face 23A, respectively 24A, arranged withdrawn, along the tilting axis Y20, from the counter-cam surfaces 25, respectively 26. In other words, the counter-cam surfaces 25, respectively 26, are protruding, along the tilting axis Y20, with respect to the aforementioned angular regions of the face 23A, respectively 24A.

In practice, in the assembled state of the clamping device 1, the counter-cam surfaces 25 are symmetrical to the counter-cam surfaces 26 relative to a geometric plane, perpendicular to the tilting axis Y20 and containing the central axis X10: for convenience, only one of the counter-cam surfaces 25 will be described in detail below, the other counter-cam surface 25 and the counter-cam surfaces 26 being deduced by the symmetry relationships previously indicated. Thus, considering one of the counter-cam surfaces 25, this counter-cam surface is, as clearly shown in the figure, globally helical, winding around the tilting axis Y20, and includes:
a main part 25.1 corresponding to a helical surface, centered on the tilting axis Y20 and having a constant pitch, i.e., a pitch whose value, which is necessarily nonzero, is constant around the tilting axis Y20, and
two opposite edges 25.2 and 25.3, which are connected to each other by the main part 25.1 and which join this main part 25.1 respectively at each of the two aforementioned angular withdrawn regions, provided on the face 23A of the lever 20.

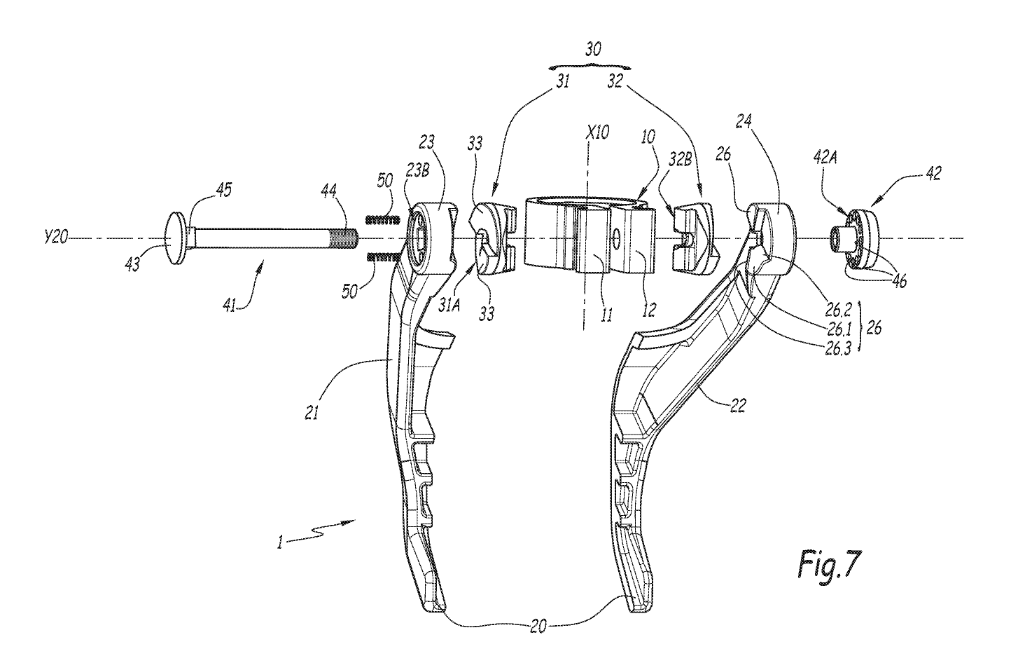

The main part 26.1 and the opposite edges 26.2 and 26.3 are also referenced for one of the counter-cam surfaces 26 in FIG. 7.

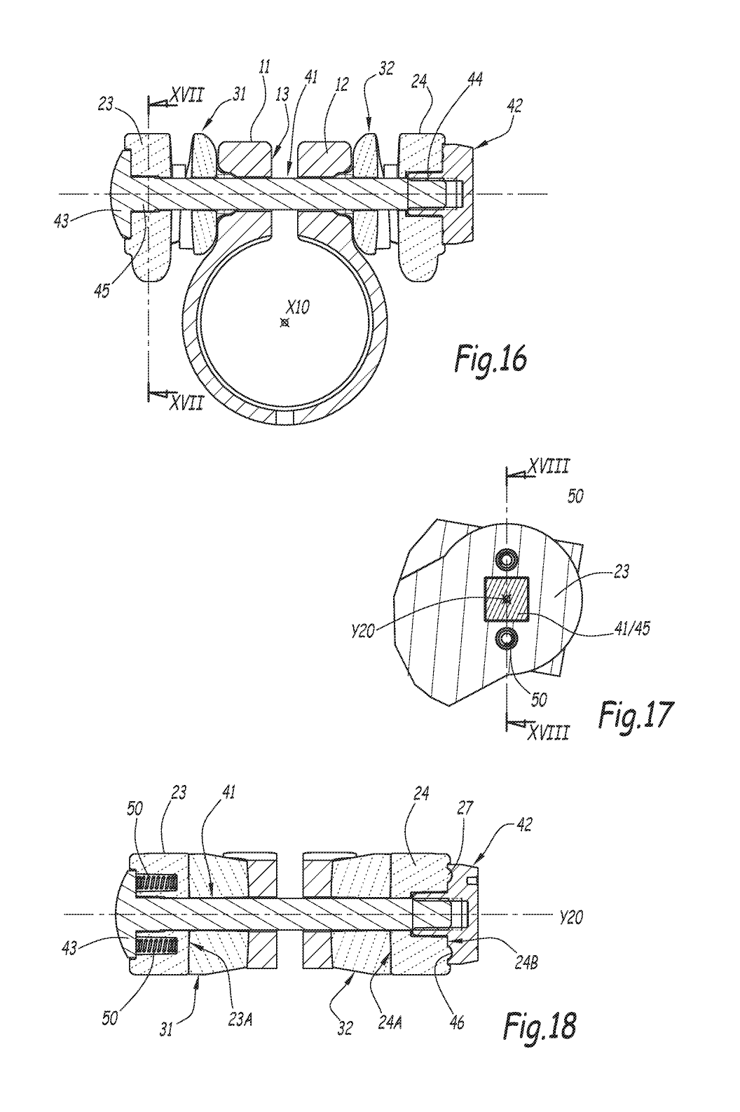

Also is clearly shown in FIGS. 6 to 8 and 11 to 18, the clamping device 1 includes a screw-nut connecting system 40 making it possible to keep the cam surfaces 33 and 34 bearing against the counter-cam surfaces 25 and 26 in all of the tilted positions of the lever 20 between its open and closed positions, inclusive. In the example embodiment considered in the figures, this screw-nut connecting system 40 includes a journal 41 and a nut 42, both centered on the tilting axis Y20. As clearly shown in FIGS. 16 to 18, in the assembled state of the clamping device 1, the journal 41 traverses the two ends 23 and 24 of the lever 20. At one of the axial ends, the journal 41 is provided with a head 43, which emerges from the end 23 of the lever 20 and which bears, along the tilting axis Y20 and in the direction of the end 11 of the clamping collar 10, against a face 23B of the end 23, opposite the face 23A of the latter. At the end of the journal 41, axially opposite its head 43, the journal 41 is provided with a thread 44 around which the nut 42 can be screwed while bearing, along the tilting axis Y20 and toward the end 12 of the clamping collar 10, against a face 24B of the end 24 of the lever 20, opposite the face 24A of this end 24. Thus, the two ends 23 and 24 of the lever 20, the two ends 11 and 12 of the clamping collar 10 and the cam system 30 are gripped, along the tilting axis Y20, between the head 43 and the nut 42, the intensity of this gripping being directly related to the expanse of the screwing of the nut 42 on the thread 44. The arms 21 and 22 of the lever 20 have a sufficient length to allow the flexion of these arms and therefore an approach along the tilting axis Y20 of the ends 23 and 24 that is necessary to adjust the clamping device 1.

In practice, the intensity of this gripping is pre-adjusted during the installation and maintenance of the clamping device 1. In other words, the user of the clamping device 1 is not meant to change the pre-adjustment of the screw-nut connecting system 40 to his liking. In this perspective, the screw-nut connecting system 40 has optional advantageous arrangements, outlined below.

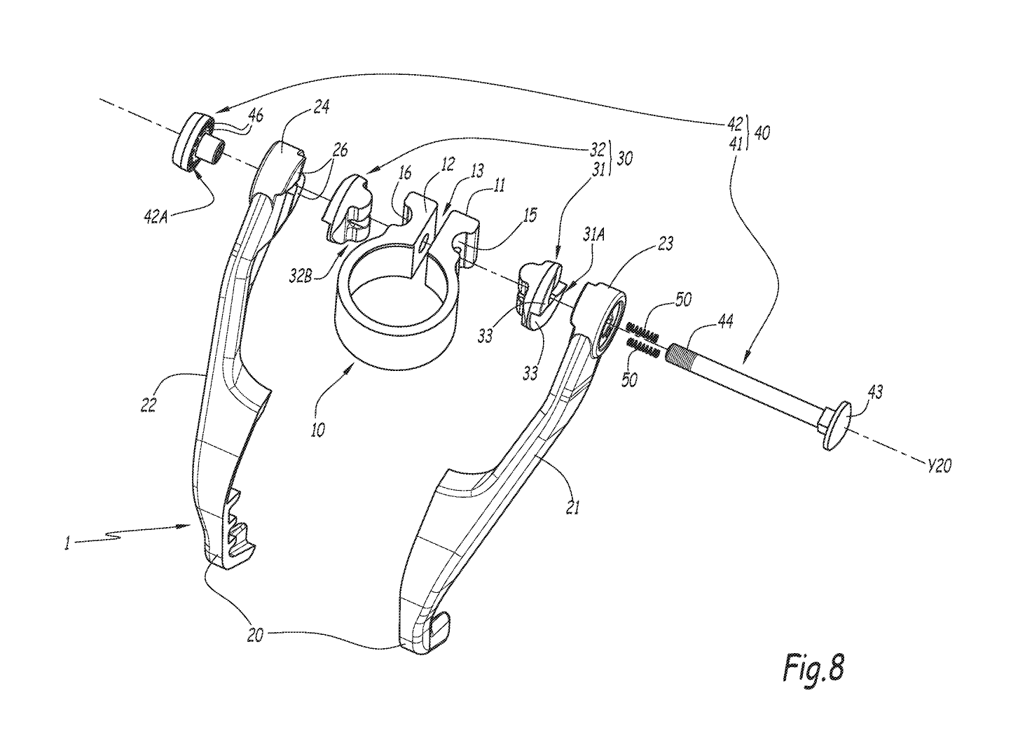

First, during the tilting of the lever 20 between its open and closed positions, the relative rotation between the journal 41 and the nut 42 is to be avoided. To that end, the journal 41 is advantageously connected in rotation, around the tilting axis Y20, to the lever 20: in the example embodiment considered in the figures, this rotational connection is provided by shape matching between a part with a square section 45 of the journal 41, located below the head 43, and a complementary housing of the end 23 of the lever 20, hollowed in the face 23B of this end 23, as clearly shown in FIG. 17. Furthermore, the nut 42 is designed to be locked in rotation, around the tilting axis Y20, relative to the end 24 of the lever 20 and a plurality of indexed positions, distributed around the tilting axis Y20: in this way, when the nut 42 occupies one of the aforementioned indexed positions, its unscrewing with respect to the journal 41 is prevented by blocking with respect to the end 24 of the lever 20, while allowing, for an installation and maintenance operator, unlocking of the nut with respect to the end 24 and thus adjusting of the screwing of the nut 42 on the thread 44. To that end, the nut 42 has, on its axial side intended to be turned toward the end 24 of the lever 20, a bearing face 42A which, during use, is pressed axially against and cooperates in an indexed manner with the face 24B of the end 24 of the lever 20. According to one advantageous embodiment, the cooperation between the faces 42A and 24B, seeking to lock the rotation of the nut 42 around the tilting axis Y20 relative to the end 24 of the lever 20, is done by shape matching: thus, in the example embodiment considered in the figures, the bearing face 42A of the nut 42 is provided with a plurality of concave spherical caps 46 which, as clearly shown in FIGS. 7 and 8, are distributed around the tilting axis Y20, while defining the aforementioned plurality of indexed positions, and which, in the assembled state of the clamping device 1, receive, in a complementary manner, one or several convex spherical caps 27 which, as clearly shown in FIGS. 6 and 18, are provided protruding on the face 24B of the end 24 of the lever 20.

Next, it is desirable to energize the clamping device 1 so that the axial bearing and bearing of the nut 42 against the end 24 of the lever 20 is blunt under all circumstances, in particular taking account of the play and drift that may appear over time within the clamping device 1, in particular due to its regular use under outdoor conditions.

To that end, a first approach consists of the clamping collar 10 being provided to be resilient such that, even when the lever 20 is in the open position, the clamping collar exerts a stress, in the tilting axis Y20, that separates the two ends 11 and 12 of the clamping collar 10 from each other. In practice, the collar is dimensioned to be resilient enough that its deformation remains resilient when the lever 20 is in the closed position. The clamping collar 10 is in particular made from a material having a good elastic strength, typically greater than 200 MPa, or even greater than 240 MPa. The clamping collar 10 can thus be made from aluminum, in particular filled with silicon and magnesium, and being made by extrusion, the clamping collar being extruded open, then machined in the stressed closed position, before being released after machining from its inner bore.

A second approach, able to be combined with the first approach, consists of providing that the element to be clamped 2 is slotted and opened in order to pre-stress the clamping collar 10 to be open. In particular, in the usage context previously mentioned in connection with a cycle, the tube of the frame of this cycle, around which the clamping device 1 is provided to be installed, can thus be provided to be open by a longitudinal slit, then radially expanded, for example using a conical mandrel, which also facilitates the sliding of the seatpost inside this tube.

A third approach, which can be combined with one and/or the other of the two aforementioned approaches, consists of inserting, along the tilting axis Y20, one or several springs between the screw-nut connecting system 40 and the rest of the clamping device 1. In the example embodiment considered in the figures, such springs, referenced 50, are thus attached, while being inserted axially between the head 43 of the journal 41 and the end 23 of the lever 20, as clearly shown in FIGS. 6 to 8, 17 and 18. As a non-limiting example, these springs 50 can provide an axial force of about 20 N. Thus, if the energization resulting from the clamping collar 10 becomes insufficient when the lever 20 is in the open position, which may happen, for example, when the clamping of the collar is done over a very large travel and/or when the collar does not have a sufficient pre-stress travel in light of this clamping travel, it is the springs 50 that essentially, or even exclusively, provide the energization of the indexing of the clamping device, by pulling the journal 41 through the lever 20 to firmly press the bearing face 42A of the nut 42 against the face 24B of the end 24 of the lever 20. In other words, under all circumstances, in particular despite any lack of resilient travel of the clamping collar 10, the springs 50 effectively activate the anti-misadjustment function described above.

Lastly, although the user of the clamping device 1 must be dissuaded from changing the adjustment of the screw-nut connecting system 40, it is preferable for the initial adjustment and subsequent maintenance adjustments to remain easy for an operator to perform. In this perspective, according to one optional arrangement, the nut 42 has arrangements, in particular shape arrangements, seeking to ensure that its rotation around the tilting axis Y20 preferably requires the use of a specific tool, for example a key provided with lugs arranged in a manner complementary to a cavity provided on a face 42B of the nut 42, opposite its face 42A. Furthermore, the setting in rotation of the nut 42 by the operator must be done so as to overcome the resistance opposed by the cooperation between the face 42A of this nut and the face 24B of the end 24 of the lever 20. It is understood that, in the case where the clamping device 1 is energized as explained above, the torque applied by the operator to the nut 42 must be high enough to overcome the resilience of the clamping collar 10 and/or the resilience of the element to be clamped 2 and/or the resilience of the springs 50 or similar attached springs. Likewise, in the case, outlined above, where the faces 42A and 24B cooperate with each other, in particular by shape matching, to lock the nut 42 relative to the lever 20 in a plurality of indexed positions around the tilting axis Y20, the faces 42A and 24B must be axially separated from each other to allow the nut to pass between two of these indexed positions: in the case where the cooperation between the faces 42A and 24B is done by the caps 46 and 27 described above, the tangency angle of these caps is advantageously provided to be smaller than 45°, such that the contact between the caps 46 and the caps 27 is reversible, such that, when the operator exerts a torque on the nut, an axial force is generated directly by the caps to separate the nut 42 from the end 24 of the lever 20. Of course, for other embodiments of the indexed cooperation between the faces 42A and 24B, the mere application of a torque to the nut 42 by the operator can prove insufficient to allow the nut to be set in rotation, the operator than having to perform an additional manipulation seeking to separate the faces 42A and 24B from each other axially, if applicable using a specific tool. In all cases, the angular indexing between the faces 42A and 24B allows the operator to count and quickly assess the number of indexing notches, necessary for the pre-adjustment or readjustment of the clamping device 1.

The different components of the clamping device 1 having been at least partially described thus far, below we will return to the detailed description of the faces 31A and 32A of the cam parts 31 and 32, in particular the cam surfaces 33 and 34 of these faces 31A and 32A. For convenience, this detailed description will be in connection with only one of the cam surfaces 33, the corresponding characteristics in connection with the other cam surface 33 and the two cam surfaces 34 being able to be deduced by the symmetry relationships: indeed, in the example embodiment considered in the figures, the two cam surfaces 33, respectively the two cam surfaces 34, are symmetrical to one another relative to the tilting axis Y20; furthermore, relative to a geometric plane, perpendicular to the tilting axis Y20 and containing the central axis X10, the cam surfaces 33 are symmetrical to the cam surfaces 34.

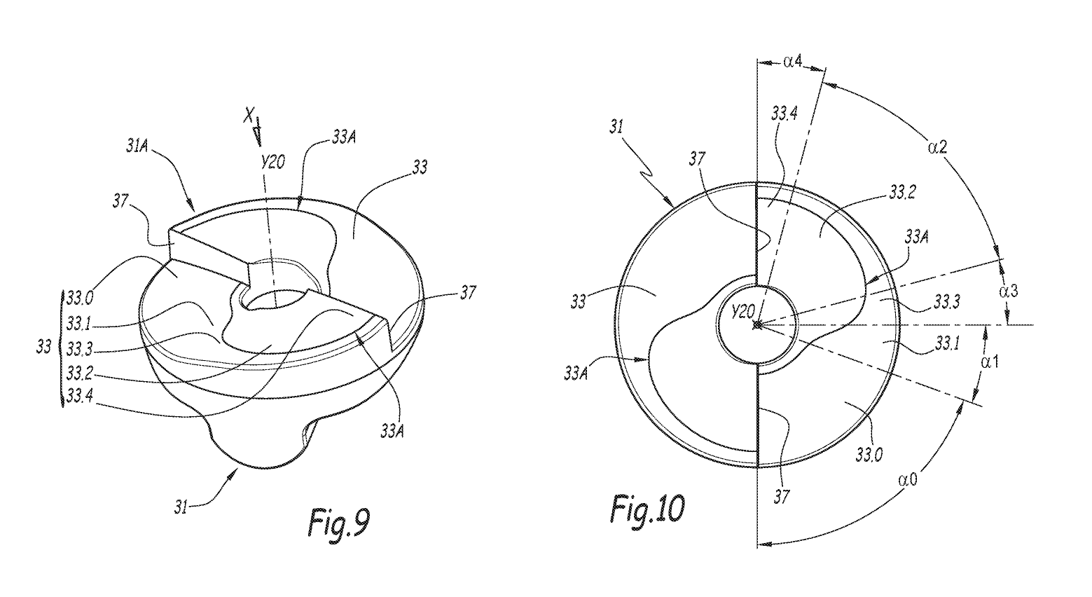

Thus, considering one of the cam surfaces 33, this cam surface is, as clearly shown in FIGS. 6 to 9, globally helical, winding around the tilting axis Y20. Furthermore, as clearly shown in FIGS. 9 and 10, this cam surface 33 successively includes:
a surface portion 33.0, which, compared to the rest of the cam surface 33, is the most withdrawn on the face 31A, and which extends around the tilting axis Y20, between its angular end opposite the rest of the cam surface 33 and its angular end connecting the surface portion 33.0 to the rest of the cam surface 33, over an angle denoted α0 in FIG. 10, this angle α0 for example being equal to about 75°;
a surface portion 33.1, which extends around the tilting axis Y20, between its angular end connecting it continuously to the surface portion 33.0 and its opposite end, over an angle denoted α1, for example equal to about 20°;
a surface portion 33.3, which extends around the tilting axis Y20, between its angular end connecting it continuously to the surface portion 33.1 and its opposite end, over an angle denoted α3, for example equal to about 15°;
a surface portion 33.2, which extends around the tilting axis Y20, between its angular end connecting it continuously to the surface portion 33.3 and its opposite angular end, over an angle denoted α2, for example equal to about 55°; and
a surface portion 33.4, which extends around the tilting axis Y20, between its angular end connecting it continuously to the surface portion 33.2 and its opposite angular end, over an angle denoted α4, for example equal to about 15°.

Furthermore, at the angular end of the surface portion 33.0, opposite the surface portion 33.1, this cam surface 33 is bordered by a springback 37 protruding from this angular end, in particular along the tilting axis Y20. In the example embodiment considered in the figures, the two cam surfaces 33 each extend over 180° around the tilting axis, such that the surface portion 33.4 of each of the cam surfaces 33 emerges, at its angular end opposite the surface portion 33.2, over the springback 37 associated with the other cam surface, as clearly shown in FIGS. 9 and 10.

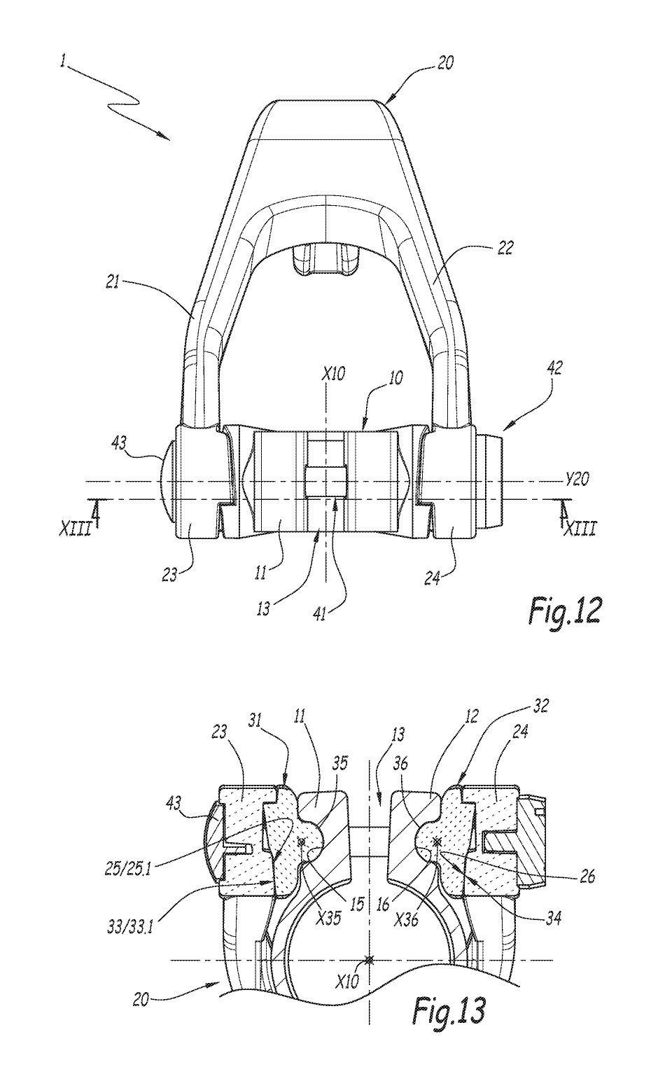

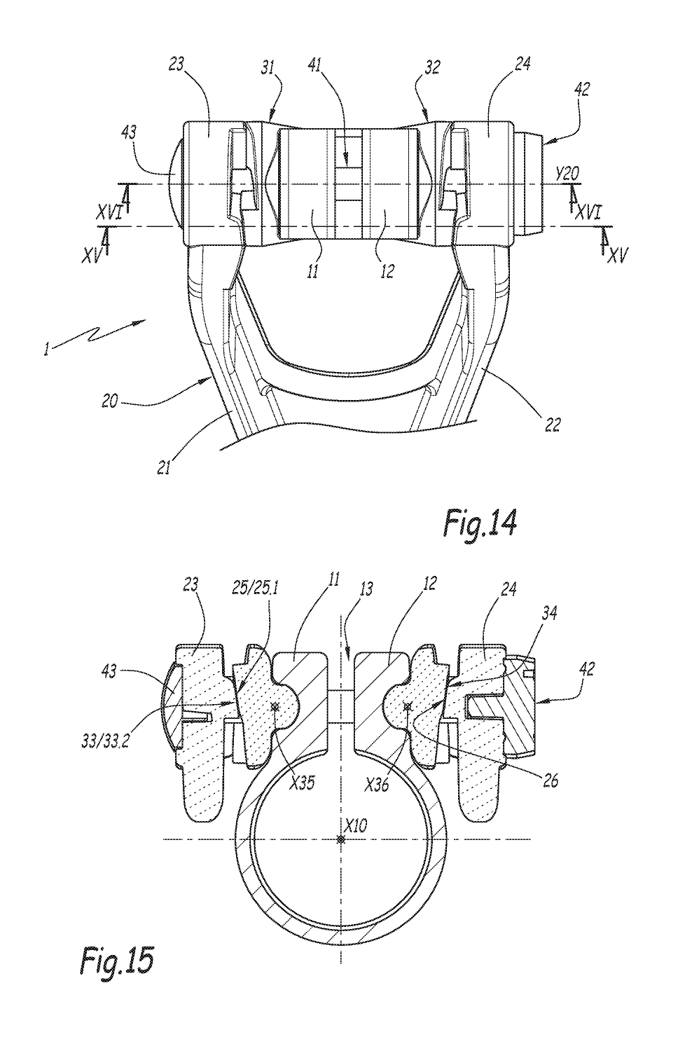

In the assembled state of the clamping device 1, the counter-cam surface 25, associated with the cam surface 33 outlined above and thus forming, with the latter, a cam surface/counter-cam surface pair, is supported on one of the surface portions 33.1 to 33.4 as a function of the tilted position of the lever 20 around the tilting axis Y20. More specifically, as clearly visible in FIGS. 12 and 13, when the lever 20 is in the open position, the counter-cam surface 25, more specifically the edge 25.2 of the latter, is supported, along the tilting axis Y20, against the surface portion 33.1: the contact between the edge 25.2 of the counter-cam surface 25 and the surface portion 33.1 can, if applicable, be limited to a quasi-periodic angular expanse zone, whereas, at the same time, the opposite edge 25.3 of the counter-cam surface 25 is abutting, in a direction peripheral to the tilting axis Y20, against the springback 37 associated with the cam surface 33. As clearly visible in FIGS. 14 and 15, when the lever 20 is in the closed position, the counter-cam surface 25, in particular the main part 25.1 of the latter, is supported, along the tilting axis Y20, against the surface portion 33.2. It is understood that, when the lever 20 goes from the open position to the closed position, the counter-cam surface 25 is pressed, along the tilting axis Y20, successively against the surface portion 33.1, the surface portion 33.3 and the surface portion 33.2. Likewise, when the lever 20 goes from the closed position to the open position, the counter-cam surface 25 is pressed, along the tilting axis Y20, successively against the surface portion 33.2, the surface portion 33.3 and the surface portion 33.2. Furthermore, it is understood that when the lever 20 tends to be tilted past its closed position, i.e., from its closed position toward a position that would move it further away from its open position, the counter-cam surface 25, in particular the edge 25.2 of the latter, bears, along the tilting axis Y20, against the surface portion 33.4.

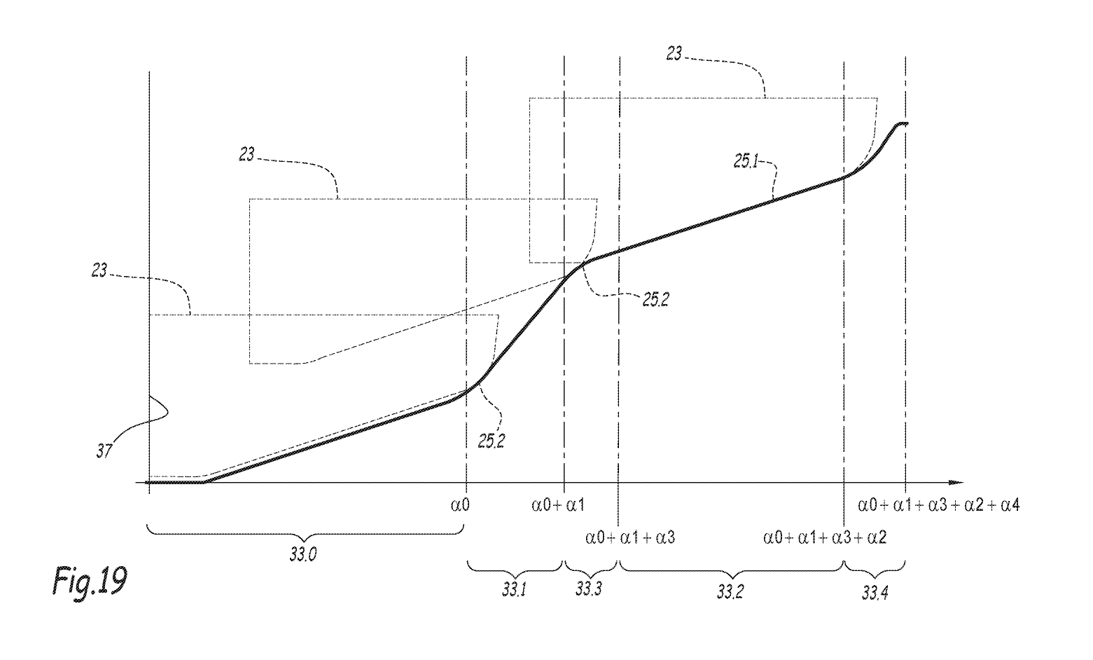

FIG. 19 allows clear viewing of the selective bearing of the counter-cam surface 25 against the surface portions 33.1 to 33.4 and against the springback 37, as a function of the position of the lever 20: in this FIG. 19, based on the angular dimension of the cam surface 33, identified by the angles α0 to α4 defined above, the axial travel, i.e., the travel along the tilting axis Y20, of the cam part 31 at its cam surface 33 is drawn, associating it with three profiles, shown in dotted lines, of the counter-cam surface 25: the leftmost profile in FIG. 19 corresponds to the open position of the lever 20 and the rightmost profile corresponds to the closed position of this lever, while the middle profile corresponds to an intermediate position of the lever between the open and closed positions. The angular travel of the lever 20 between the open and closed positions, which corresponds to the angular deviation between the leftmost profile and the rightmost profile, can thus be equal to about 90°, as mentioned above in the context of the use of the clamping device 1 to clamp the seat of a cycle.

FIG. 19 also makes it possible to see that the surface portions 33.1 to 33.4 are not found, in the graph of this FIG. 19, in the form of aligned respective slopes. On the contrary, at the surface portion 33.1, i.e., between the angular dimensions α0 and α0+α1, the graph of FIG. 19 shows a steeper slope than at the surface portion 33.2, i.e., between the angular dimensions α0+α1+α3 and α0+α1+α3+α2. Thus, the pitch of the cam surface 33 is larger over the surface portion 33.1 than over the surface portion 33.2, having noted that the interest of this arrangement will appear a bit later. The variation of the pitch between the surface portions 33.1 and 33.2 is accommodated continuously by the surface portion 33.3, which thus provides a gradual transition, as clearly shown in FIG. 19. It is understood that, alternatively, the surface portion 33.3 can have a smaller angular expanse than in the example of the figures, or even have a quasi-periodic angular expanse, as long as this surface portion 33.3 physically provides the transition, if applicable geometrically discontinuous, between the surface portions 33.1 and 33.2.

As illustrated by FIG. 19, the pitch of the surface portion 33.2 is provided to be substantially equal to the pitch of the main part 25.1 of the cam surface 25. In practice, the respective pitches of the surface portion 33.2 and the main part 25.1 of the cam surface 25 are equal, to within functional play. More globally, the surface portion 33.2 can advantageously be provided to be congruent with the counter-cam surface 25: this way, when the lever 25 is in the closed position, the contact interface between the cam surface 33 and the counter-cam surface 25 is very extended, substantially corresponding to the entire surface portion 33.2, which distributes, over the latter, the bearing stresses between the cam surface 33 and the counter-cam surface 25. The creep of the material making up the cam surface 33 is thus avoided, which advantageously makes it possible to consider manufacturing the cam surface 33 with a creep-sensitive material, in particular a thermoplastic material, such as polyacetal or PBT (polybutylene terephthalate). The interest of using such a material to produce the cam surface 33 and, more generally, to produce the entire corresponding cam part 31, is that this material is simultaneously cost-effective, in particular in that this material can be injected in a mold for shaping the surface of the cam 33, wear-resistant, and with a low friction coefficient.

At the same time, the fact that there is no congruence between the surface portions 33.1 and 33.3 and the counter-cam surface 25 means that, during the passage of the lever 20 between the open and closed positions, the bearing of the counter-cam surface 25 against the surface portions 33.1 and 33.3 causes a high contact pressure: however, this does not cause creep of the material making up the cam surface 33, since this contact pressure is only established for a very short period of time, during the transition between the open and closed positions. Furthermore, when the lever goes from the open position to the closed position and the lever is about to reach the closed position, the contact interface between the cam surface and the counter-cam surface does not stop increasing, reaching a maximum at the end of clamping whereas, at the same time, the clamping force increases practically linearly up to its maximum in the closed position.

FIG. 19 further makes it possible to understand that the surface portion 33.0 of the cam surface 33 has no functional interest, in that this surface portion 33.0 does not need to establish pressing contact with the counter-cam surface 25. In particular, when the lever 20 is open, the counter-cam surface 25 cooperates by bearing with the surface portion 33.1 and the springback 37, as explained above, while being able to remain at a distance from the surface portion 33.0, in particular by providing sufficient play between them, as illustrated in FIG. 19. Of course, as an alternative that is not shown, the surface portion 33.0 can have a smaller, or even nonexistent, expanse subject to an increased expanse for the surface portion 33.1.

Returning to the description of the cam surface 33 shown in FIGS. 9 and 10, it will be noted that this cam surface 33 is curved so as to form a peak 33A that, as clearly shown in FIGS. 9 and 10, winds around the tilting axis Y20, while extending at least over the surface portions 33.1 and 33.2 of the cam surface 33. In the example embodiment considered here, the peak 33A extends continuously over the surface portions 33.1, 33.2 and 33.3, while extending even over the surface portions 33.0 and 33.4. This being said, as an alternative that is not shown, the peak 33A can extend discontinuously over these surface portions, if applicable only running over part of only one or several of these surface portions. In all cases, the peak 33A corresponds, in any cutting plane containing the tilting axis Y20, to the point protruding most from the cam surface 33, in other words the apex of the curved profile of the cam surface. In practice, this curved profile of the cam surface 33 has a very large curve radius. During use, i.e., when the surface of the counter-cam 25 is pressed against the cam surface 33, the corresponding bearing stresses are concentrated at the peak 33A.

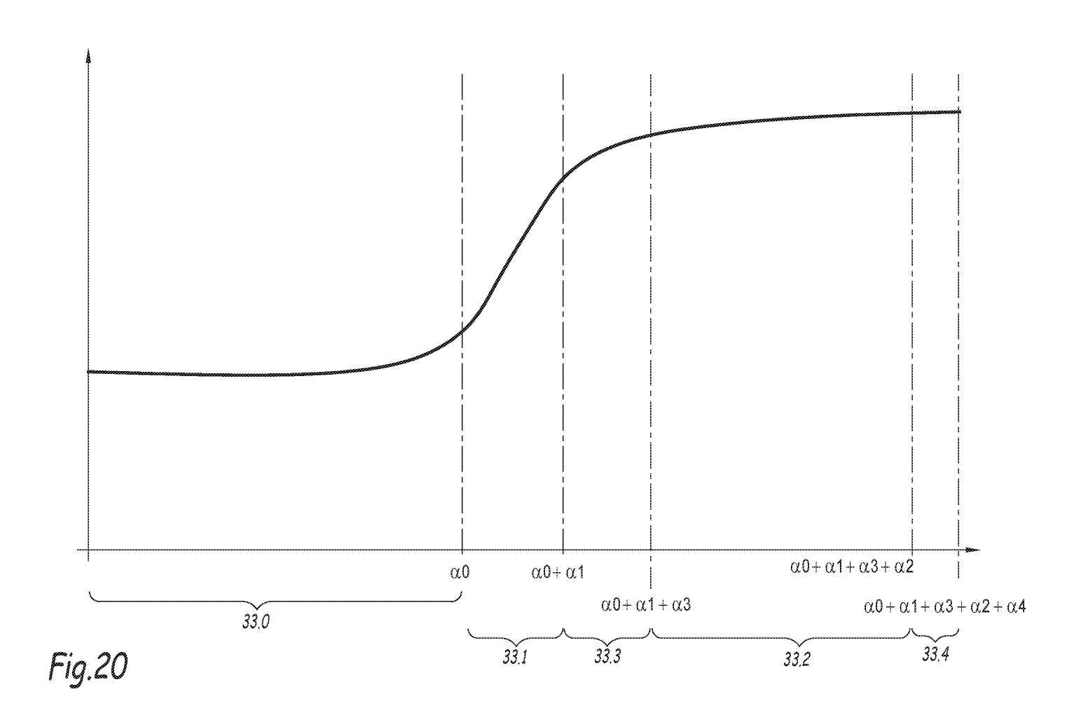

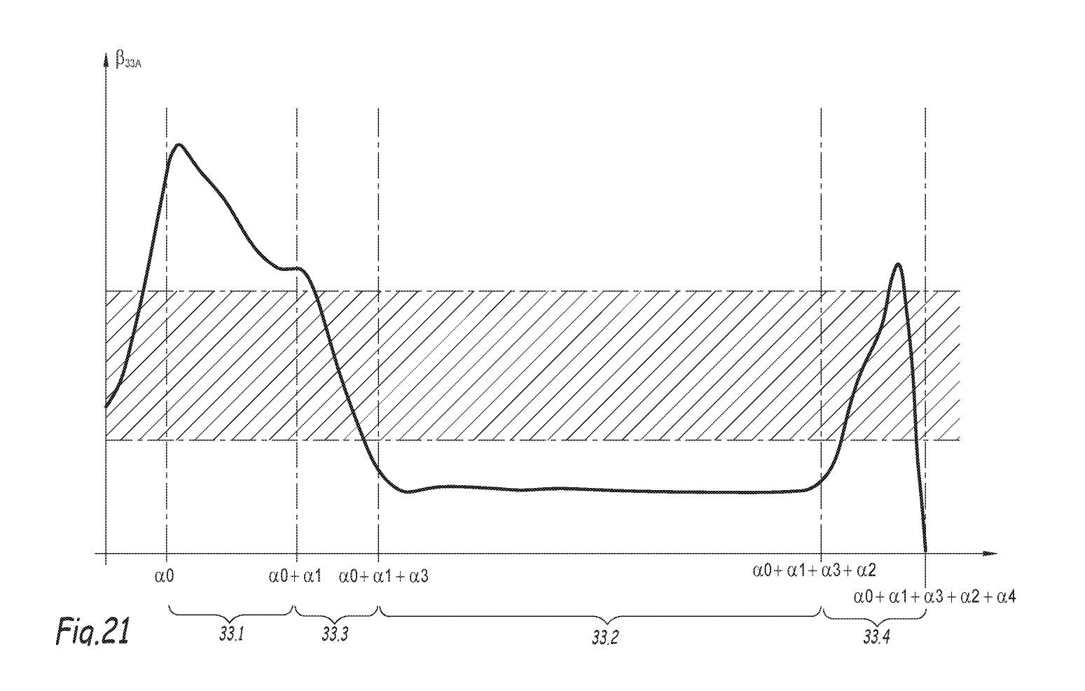

This concentration of the stresses at the peak 33A can be taken advantage of to improve the behavior of the cam system 30. To do this, according to one arrangement whose interest will appear a bit later, the radius, i.e., the distance radially to the tilting axis Y20, of the peak 33A is not constant around this axis, but varies as a function of the angular dimension of the cam surface 33, as clearly shown in FIGS. 9 and 10 and as illustrated in FIG. 20, which shows this evolution of the radius of the peak 33A. Thus, the radius of the peak 33A is smaller on the surface portion 33.1 of the surface of the cam 33, i.e., between the angular dimensions α0 and α0+α1, than on the surface portion 33.2, i.e., between the angular dimensions α0+α1+α3 and α0+α1+α3+α2. The difference in radius between the surface portions 33.1 and 33.2 is accommodated by the surface portion 33.3, on which the radius of the peak varies continuously to perform the transition between the surface portions 33.1 and 33.2. In practice, within each of the surface portions 33.1 and 33.2, the radius of the peak 33A cannot be strictly constant, but may, like in the example shown in the figures, vary, having noted that, for reasons that will appear a bit later, the value of the radius is advantageously minimal in the region of the surface portion 33.1, opposite the surface portion 33.2, and the value of the radius is advantageously maximum in the region of the surface portion 33.2, opposite the surface portion 33.1.

Simultaneously taking account of the arrangement mentioned above, in which the pitch of the cam surface 33 is larger on the surface portion 33.1 than on the surface portion 33.2, and the other arrangement mentioned above, in which the radius of the peak 33A is smaller on the surface portion 33.1 than on the surface portion 33.2, it is understood that the peak 33A has a helix angle β_{33A} that, without changing signs, evolves significantly based on the angular dimension of the cam surface 33, having recalled that this helix angle, which is measured relative to a plane perpendicular to the tilting axis Y20, satisfies the relationship (1) given in the introduction. FIG. 21 makes it possible to view this variation of the helix angle β_{33A}. In particular, the helix angle β_{33A}, which is positive over the entire functional expanse of the cam surface 33, is larger on the surface portion 33.1, i.e., between the angular dimensions α0 and α0+α1, than on the surface portion 33.2, i.e., between the angular dimensions α0+α1+α3 and α0+α1+α3+α2. Of course, on each of the surface portions 33.1 and 33.2, the value of the helix angle β_{33A} may not be constant, but may vary, as shown in FIG. 21: advantageously, on the surface portion 33.1, the helix angle β_{33A} is maximal in the region of the latter opposite surface portion 33.2; on the surface portion 33.2, the helix angle β_{33A} is minimal in the region of the latter opposite surface portion 33.1. Between the surface portions 33.1 and 33.3, the surface portion 33.2 accommodates the variation of the helix angle β_{33A}.

More generally, as illustrated by FIG. 21, the value of the helix angle β_{33A} on the surface portion 33.1 and the value of the helix angle β_{33A} on the surface portion 33.2 are respectively provided to be greater and less than an angle region, which is crosshatched in FIG. 21 and on either side of which the pairing between the cam surface 33 and the counter-cam surface 25 does not have the same stability, in that, above this region, this behavior is unstable, in other words reversible, while below this region, this behavior is stable, in other words irreversible. This stability aspect should be compared to FIG. 2, shown at the beginning of this document, in that the aforementioned region corresponds to φ, i.e., the arc tangent of the friction coefficient for the pair of materials making up the cam surface 33 and the counter-cam surface 25, considering that this friction coefficient belongs to a given value range, the expanse of which explains the expanse on the y-axis of the aforementioned angle region. As an example, when the cam surface 33 is made from polyacetal and the lever is made from polyamide filled with glass fibers, the friction coefficient of this pair of materials can be considered to be comprised between 0.1 and 0.23, such that φ is comprised between about 6° and 13°. In the extension of this example, it is understood that the helix angle β_{33A} is advantageously provided to be greater than 13°, or even 14° over the entire surface portion 33.1, and provided to be less than 6°, or even 5° over the entire surface portion 33.2.

Taking the foregoing explanations into account, as well as explanations given in connection with FIG. 2, it is understood that:
when the lever 20 is in the open position and tends, under the effect of its own weight, to tilt toward the closed position, the reversibility of the bearing between the counter-cam surface 25 and the surface portion keeps the lever 20 in the open position, having noted that, advantageously, the energization, outlined above, of the clamping device 1 tends to force the lever 20 to remain “as open as possible”, i.e., as illustrated by the leftmost profile of lever in FIG. 19; and
when the lever 20 is in the closed position, the bearing between the counter-cam surface 25 and the surface portion 33.2 of the cam surface 33 is irreversible, which stabilizes the lever 20 in the closed position, preventing any untimely tilting of the lever 20 toward its open position when the user is not applying a strong enough torque to overcome the irreversibility of this bearing.

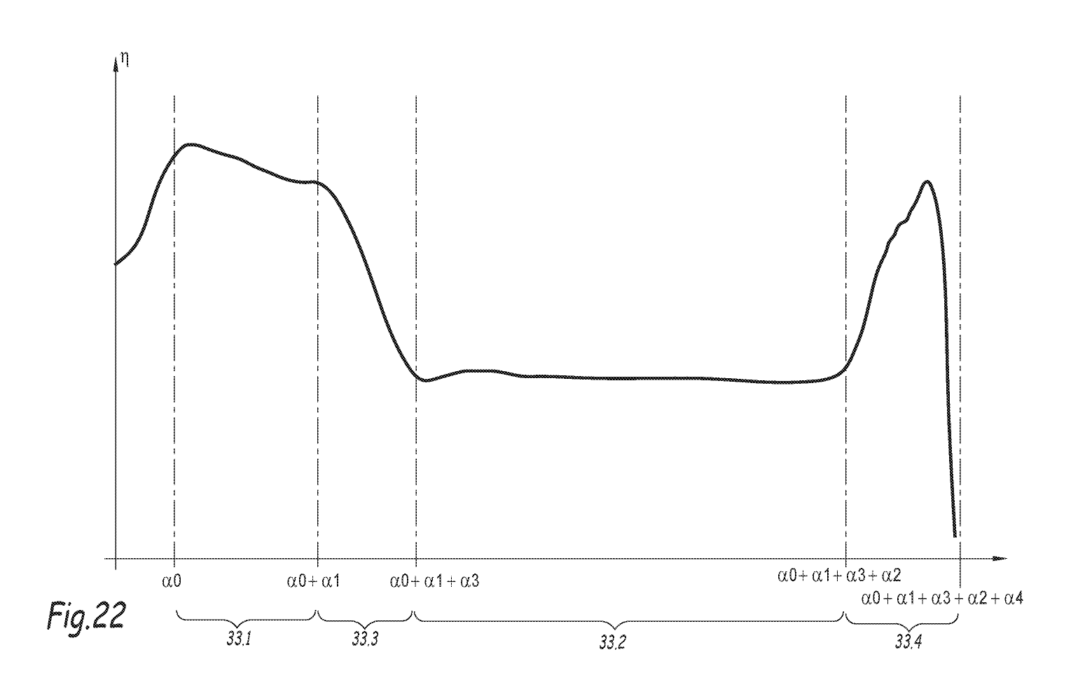

The evolution of the helix angle β_{33A} is also beneficial for the performance of the clamping by the cam surface 33, as illustrated by FIG. 22, having recalled that the clamping performance was previously defined by relationship (5). In particular, FIG. 22 shows that when the lever 20 goes from the open position to the closed position, the clamping performance is very good, compared to that when the lever is in the closed position. It is in this transitional phase that the high pitch of the surface portion 33.1 makes it possible to significantly increase the clamping travel, without increasing the maximum clamping torque as mentioned below.

Likewise, the clamping torque and the loosening torque, which the user must apply to the lever 20 to close it and open it, are favorably affected by the conformation, outlined thus far, of the cam surface 33.

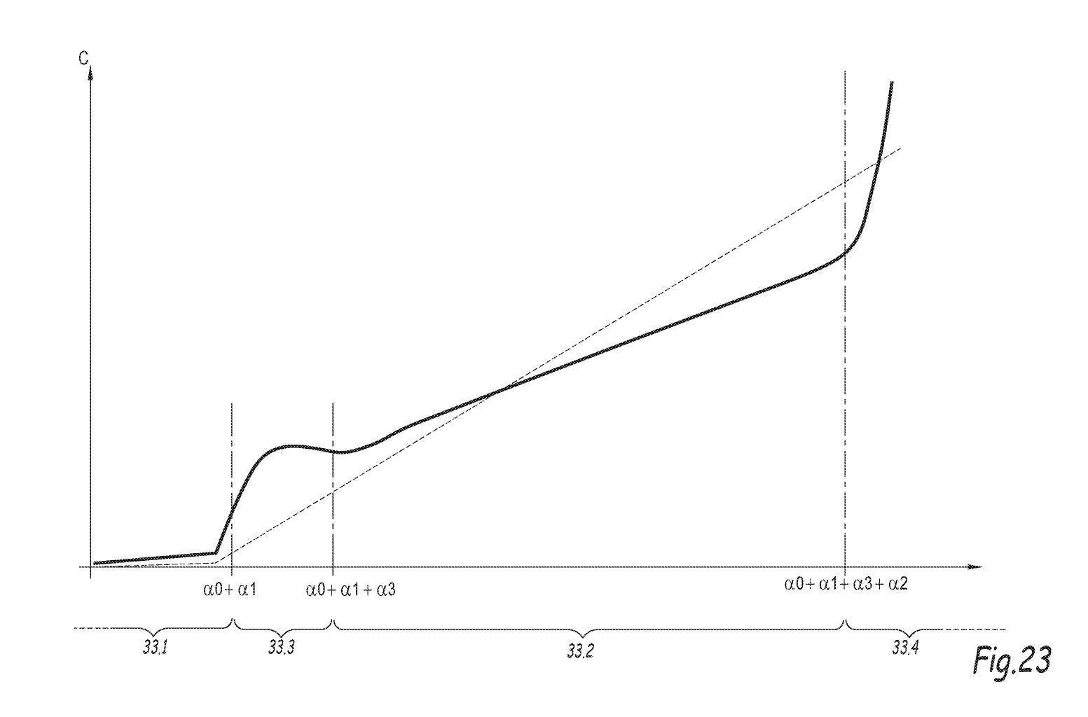

FIG. 23, which shows the evolution of the clamping torque, in connection with relationship (4) given above, as a function of the angular position of the lever identified by the angular dimensions α0, α1, α2, α3 and α4 outlined above, makes it possible to observe that the force to be applied by the user is significant only during the initiation of the clamping, i.e., when the lever 20 leaves its open position toward its closed position, while next increasing to a much smaller extent, until reaching a maximum value. Compared to the clamping torque to be applied to a helical cam surface with a constant pitch and with the inner and outer perimeters with constant respective radii, the evolution of which is shown in dotted lines in FIG. 23 and which is strictly linear between the open and closed positions of the lever, the aforementioned maximum value is lower than the force that the user must produce to reach the closed position. FIG. 23 also shows that, beyond the closed position, the cam surface 33 causes an abrupt increase in the clamping torque, which is related to the presence of the surface portion 33.4: owing to this surface portion 33.4, the user clearly feels that he has tilted the lever 20 to the closed position, without it being necessary to tilt the lever further.

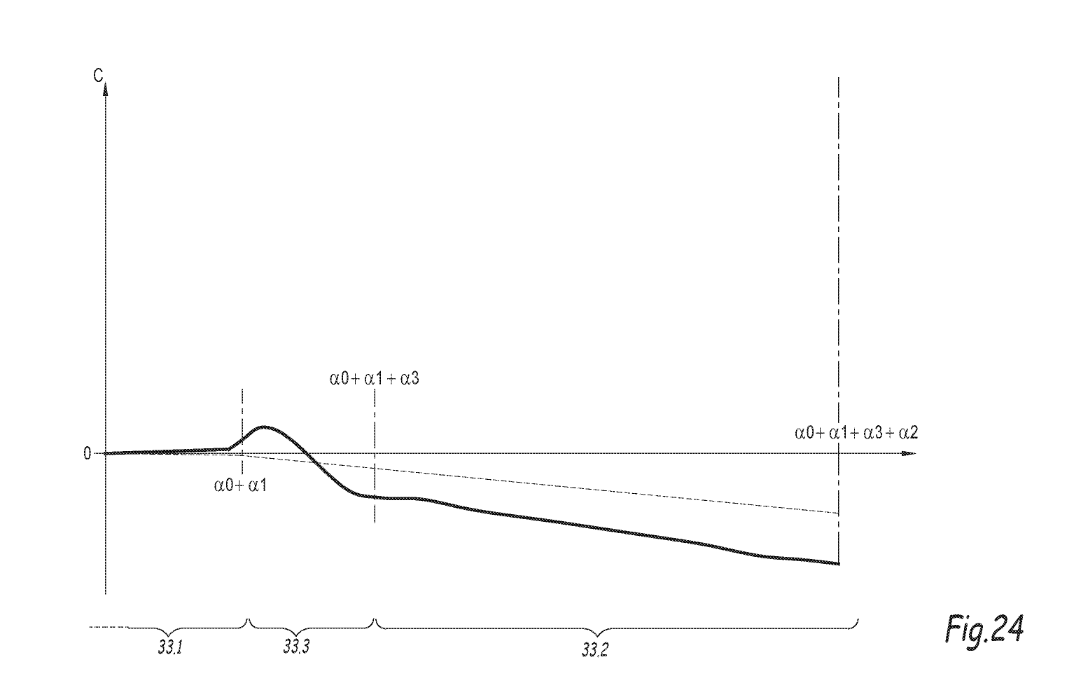

FIG. 24 illustrates the evolution of the loosening torque, in connection with relationship (7) given above. FIG. 24 makes it possible to see that the torque to be applied by the user, which is negative when the lever 20 leaves its closed position toward its open position, becomes positive when the lever is close to reaching its open position: in other words, once the user has moved the lever 20 far enough away from its closed position toward its open position, the lever tilts reversibly, automatically, to its open position, which provides a clear indication to the user that this open position has thus been reached. Furthermore, compared to the loosening torque for a helical cam surface with a constant pitch and with inner and outer perimeters with constant respective radii, the evolution of which is shown in dotted lines in FIG. 24, the cam surface 33 makes it possible to have greater stability upon initiation of the loosening, in that upon initiation of the loosening, the loosening torque to be applied to the cam surface 33 is much more negative than that for a helical cam surface with a constant pitch and with inner and outer perimeters having constant respective radii.

Based on the considerations developed thus far, it is understood that varying the helix angle β_{33A} of the peak 33A, in order for this helix angle to be larger at the surface portion 33.1 than at the surface portion 33.2, has substantial and many interests for the clamping device 1. As explained above, in the example embodiment considered in the figures, the variation of the helix angle β_{33A} is related in part to the variation of the pitch between the surface portions 33.1 and 33.2, and for another part, to the variation of the radius of the peak 33A, in connection with relationship (1) given above. Of course, rather than playing with both the pitch and the radius of the peak, it is possible, in the alternative, to play with only one or the other of these two arrangements. In other words, one alternative consists of each cam surface having a constant pitch, but being provided with a peak having a variable radius, such as the peak 33A for the cam surfaces 33. Another alternative consists of each cam surface being provided with a peak having a constant radius, while having a variable pitch between its portions corresponding to the surface portions 33.1 and 33.2 as described in the figures.

Still another possibility for alternatives concerns the peak 33A itself. Indeed, such a peak may not be provided on the cam surfaces 33: in this case, the profile, in section in any axial plane containing the tilting axis Y20, of each cam surface is rectilinear. The variation of the helix angle no longer being able to be assessed along a peak similar to the peak 33A, this variation is assessed, for each cam surface, along a geometric helix, which is centered on the tilting axis Y20 and which, in section in any axial plane containing the tilting axis Y20, has a radius satisfying relationship (2) given above, i.e., an equivalent radius req equal to ⅔·(rext³−rint³)/(rext²−rint²), where rext and rint are outer and inner radii, respectively, of the cam surface, measured in the aforementioned axial plane. There is cause to understand that this geometric helix is functionally similar to the peak 33A considered for the example examined in the figures, in that both the peak 33A, and this geometric helix in the absence of a peak, constitute a bearing helix, which winds around the tilting axis Y20, while extending at least partially over the surface portions 33.1 and 33.2 of the cam surface 33, and at which level the bearing stresses are applied between the cam surface 33 and the associated counter-cam surface 25. Of course, in the alternative considered here, where each cam surface has no peak, but defines the aforementioned geometric helix, the variation of the helix angle of this geometric helix results either from the variation of the pitch between the surface portions 33.1 and 33.2 of the cam surface, or from an appropriate variation of the outer radius and/or the inner radius of the cam surface, or from the combination of these two arrangements respectively relative to the pitch and the inner and outer radii of the cam surface.

Various arrangements and alternatives to the clamping device 1 described thus far may also be considered:
the arrangement of the cam surfaces 33 and 34 and counter-cam surfaces 25 and 26 on, respectively, the cam parts 31 and 32 and the ends 23 and 24 of the lever 20 can be reversed;
rather than providing two cam surfaces 33, respectively 34, for each of the cam parts 31 and 32, only one cam surface can be provided, then being associated with a single counter-cam surface;
rather than providing two, only one cam part 31 or 32 can be provided; and/or
rather than using deformation, the clamping collar 10 can be provided articulated to make it possible to bring its ends 11 and 12 relatively closer/further apart.

What is claimed is:

1. A clamping device, including:
a clamping collar, which defines a central axis, which is intended to surround, in a substantially coaxial manner, an element to be clamped and which is open so as to have two ends able to come closer to one another in order to grip the element to be clamped, and
a lever, which is mounted tilting on the ends of the clamping collar around a tilting axis extending substantially perpendicular to the central axis, and which is connected to the clamping collar by a cam system which is able to be actuated by tilting of the lever around the tilting axis between an open position, in which the clamping collar is loosened, and a closed position, in which the clamping collar is tightened;
wherein the cam system includes at least one pair associating a cam surface and a counter-cam surface, which are each globally helical, winding around the tilting axis, and which are connected in rotation around the tilting axis, respectively, to one of the clamping collar and the lever and to the other of the clamping collar and the lever;
wherein the cam surface of the or each pair of the cam system includes:
a first surface portion against which the associated counter-cam surface is pressed along the tilting axis both when the lever is in the open position and when the lever is tilted from the open position toward the closed position, and
a second surface portion, which is connected to the first surface portion by a third surface portion of the cam surface, and against which the associated counter-cam surface is pressed along the tilting axis both when the lever is in the closed position and when the lever is tilted from the closed position toward the open position;
wherein the counter-cam surface of the or each pair of the cam system includes a main part, which is helical, being centered on the tilting axis and having a constant pitch, and which is pressed along the tilting axis against the second surface portion of the associated cam surface when the lever is in the closed position;
wherein the cam surface of the or each pair of the cam system defines a bearing helix at which bearing stresses are applied between the cam surface and the associated counter-cam surface, said bearing helix winding around the tilting axis and extending at least partially over the first and second surface portions of the cam surface; and
wherein the bearing helix of the cam surface of the or each pair of the cam system has a helix angle, measured relative to a plane perpendicular to the tilting axis, that is larger on the first surface portion of the cam surface than on the second portion of the cam surface, while this second portion of the cam surface of the or each pair of the cam system has a pitch that is substantially equal to the constant pitch of the main part of the associated counter-cam surface.

2. The clamping device according to claim 1, wherein the cam surface of the or each pair of the cam system is curved so as to form a peak for concentrating the bearing stresses between the cam surface and the associated counter-cam surface, said peak forming the bearing helix.

3. The clamping device according to claim 1, wherein the cam surface of the or each pair of the cam system has, in section in any axial plane containing the tilting axis and intersecting the cam surface, a rectilinear profile, and
wherein the bearing helix corresponds to a geometric helix, which is centered on the tilting axis and which, in section in any axial plane containing the tilting axis and intersecting the cam surface, has a radius that is equal to ⅔·(rext³−rint³)/(rext²−rint²), where rext and rint are outer and inner radii, respectively, of the cam surface, measured in said axial plane.

4. The clamping device according to claim 1, wherein the cam surface of the or each pair of the cam system has a pitch that is larger on the first surface portion of the cam surface than on the second portion of the cam surface.

5. The clamping device according to claim 1, wherein the bearing helix of the cam surface of the or each pair of the cam system has a radius, measured relative to the tilting axis, that is smaller on the first surface portion of the cam surface than on the second portion of the cam surface.

6. The clamping device according to claim 1, wherein the helix angle of the bearing helix of the cam surface of the or each pair of the cam system is:
greater than 13° over substantially the entire first surface portion of the cam surface, and
less than 6° over substantially the entire second surface portion of the cam surface.

7. The clamping device according to claim 1, wherein the helix angle of the bearing helix of the cam surface of the or each pair of the cam system is:
greater than 14° over substantially the entire first surface portion of the cam surface, and
less than 5° over substantially the entire second surface portion of the cam surface.

8. The clamping device according to claim 1, wherein the second surface portion of the cam surface of the or each pair of the cam system is congruent with the associated counter-cam surface.

9. The clamping device according to claim 1, wherein the cam surface of the or each pair of the cam system further includes a fourth surface portion that extends from the second surface portion opposite the third surface portion, being connected to the second surface portion continuously, and
wherein the pitch of the cam surface of the or each pair of the cam system is larger on the fourth surface portion of the cam surface than on the second surface portion.

10. The clamping device according to claim 1, wherein the cam system includes two pairs whose respective cam surfaces are symmetrical to one another relative to the tilting axis.

11. The clamping device according to claim 1, wherein the cam system includes two pairs whose respective cam surfaces are respectively arranged on either side, along the tilting axis, of the two ends of the clamping collar.

12. The clamping device according to claim 1, wherein the cam system includes at least one cam part:
that is distinct from the clamping collar and the lever, while being interposed, along the tilting axis, between the lever and one of the ends of the clamping collar,
which, for each pair of the cam system, delimits, on a first face of the cam part, either the corresponding cam surface, or the corresponding counter-cam surface, and
which, on a second face of the cam part that is opposite the first face along the tilting axis, is provided with a cylindrical surface, which is centered on a pivot axis parallel to the central axis and secant to the tilting axis, and which cooperates by shape matching with a cylindrical surface of the clamping collar such that the cam part is both connected in rotation around the tilting axis to the clamping collar and pressed along the tilting axis against the collar, while allowing pivoting travel around the pivot axis.

13. The clamping device according to claim 1, wherein the clamping device further comprises a journal, which traverses the two ends of the clamping collar while being centered on the tilting axis, which is connected in rotation around the tilting axis to the lever, and which is provided, in an axially opposite manner along the tilting axis, with a head and a thread to which a nut is screwed, such that the two ends of the clamping collar, the lever and the cam system are gripped, along the tilting axis, between the head and the nut,
and wherein the nut includes a bearing face, which is pressed, along the tilting axis, against an indexing face of the lever, while cooperating with this indexing face so as to lock the rotation of the nut around the tilting axis relative to the latter in a plurality of indexed positions, passing the nut between two of these indexed positions being operated by axial separation between the bearing face and the indexing face.

14. The clamping device according to claim 13, wherein the bearing face cooperates with the indexing face by shape matching.

15. The clamping device according to claim 13, wherein one of the bearing face and the indexing face is provided with a plurality of concave spherical caps, which are distributed around the tilting axis while defining the plurality of indexed positions, and wherein the other of the bearing face and the indexing face is provided with at least one convex spherical cap that is selectively received in a complementary manner in one of the concave spherical caps.

16. The clamping device according to claim 13, wherein the clamping device further comprises at least one spring that is interposed, along the tilting axis, between the journal and the lever so as to press the bearing face and the indexing face against each other along the tilting axis.

17. The clamping device according to claim 1, wherein the clamping collar is provided to be resilient such that, even when the lever is in the open position, the clamping collar exerts a resilient stress that moves the two ends of the clamping collar away from each other.

18. The clamping device according to claim 1, wherein the cam surface of the or each pair of the cam system is made from a thermoplastic material.

19. The clamping device according to claim 18, wherein the cam surface of the or each pair of the cam system is made from polyacetal or PBT.

20. The clamping device according to claim 1, wherein the clamping device is provided to clamp a saddle for a cycle, the clamping collar being intended to surround a tube for receiving a seatpost.
